(19) United States
(12) Patent Application Publication
(10) Pub. No.: US 2026/0094467 A1
(43) Pub. Date: Apr. 2, 2026

(54) SYSTEM AND METHOD FOR CENTRALIZED PERSON RE-IDENTIFICATION AND UNIQUE PERSON ID RETENTION ACROSS MULTIPLE CAMERAS

(71) Applicant: Elm, Riyadh (SA)

(72) Inventors: Athul M. MATHEW, Riyadh (SA); Thariq KHALID, Riyadh (SA); Zaheer SHERIFF, Riyadh (SA); Arshad Ali KHAN, Riyadh (SA); Haithem Ali HERMASSI, Riyadh (SA); Riad SOUISSI, Riyadh (SA)

(73) Assignee: Elm, Riyadh (SA)

(21) Appl. No.: 19/289,875

(22) Filed: Aug. 4, 2025

Related U.S. Application Data
(60) Provisional application No. 63/702,012, filed on Oct. 1, 2024.

(51) Int. Cl. G06V 40/10; G06T 7/00; G06V 10/74; G06V 10/762; G06V 10/94

(52) U.S. Cl. CPC G06V 40/103; G06T 7/97; G06V 10/761; G06V 10/762; G06V 10/945

(57) ABSTRACT

A system and a method for tracking individual persons across multiple cameras and over extended periods include an event streaming processing circuitry, a server, an application processing circuitry, a Tensor Database system and an output device. The event streaming processing circuitry receives streams of data from the cameras. The server includes Artificial Intelligence (AI) based models for person detection and embedding vector extraction to obtain person bounding box images and person embedding vectors. The application processing circuitry includes an Embedding Manager that maintains a collection of distinct embedding vectors for each person and an ID Manager that maps short-term person IDs to respective long-term IDs. The ID Manager associates the person with a unique long-term ID across the cameras. The Tensor Database system maintains the extracted embedding vectors. The output device tracks the person appearing across the cameras based on the long-term ID.

### CROSS-REFERENCE TO RELATED APPLICATIONS

This application claims the benefit of priority to provisional application No. 63/702,012 filed Oct. 1, 2024, the entire contents of which are incorporated herein by reference.

### BACKGROUND

### Technical Field

The present disclosure is directed to computer vision and artificial intelligence, and more particularly, to systems and methods for centralized person re-identification and unique person identity (ID) retention across multiple cameras.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Person re-identification refers to a process in which a system assigns a unique identifier (ID) to a person visible within a field of view of a camera. This capability is essential for applications such as people counting using Closed-Circuit Television (CCTV) camera feeds, which is significant in scenarios like monitoring entry and exit points of shopping malls for crowd management, identifying shopping trends, and similar use cases.

Conventional tracking methods, such as Simple Online and Real-Time Tracking (SORT), rely on basic data association and state estimation techniques. The SORT operates by analyzing positional data of observations across past and current frames. However, it does not explicitly account for object appearance during the data association. While the SORT is efficient for real-time object tracking, it faces limitations in occlusion scenarios. For example, when the person is temporarily hidden by another object or individual and later reappears, the SORT often assigns a new ID, disrupting a continuity of tracking. Similarly, when the person exits the field of view of the camera and re-enters after a prolonged period, the SORT cannot maintain identity persistence, treating the person as a new individual. These limitations also apply to multi-camera scenarios, where transitions from one camera's view to another often result in inconsistent ID assignment due to a lack of shared identity information between camera streams.

Advanced techniques like Deep SORT and Strong SORT address some of these challenges by incorporating object appearance features derived from deep neural networks. These techniques are equipped to handle short-term occlusions and prevent erroneous ID assignments in overlapping bounding boxes. However, their application is largely restricted to short-term ID retention within a single camera feed. Default implementations of the Deep SORT and the Strong SORT store tracking data in a system memory, maintaining a history of up to 200 frames, depending on a configuration. Despite these improvements, these techniques are computationally intensive and unable to maintain long-term memory due to processing constraints. Moreover, they lack mechanisms for sharing memory or identity data across multiple camera streams, making cross-camera person re-identification unreliable.

Additionally, in crowded environments, conventional systems struggle with accurate identification due to significant overlap between individual bounding boxes, often leading to identity switching or reassignment errors. When multiple individuals are occluded or overlap within the same scene, IDs previously assigned to one person may be incorrectly reassigned to another person, further disrupting tracking continuity.

CN108960127B discloses a shielded pedestrian re-identification method based on adaptive depth measurement learning. In this method, a convolution neural network, designed to be robust against occlusions, is trained and subsequently used for pedestrian re-identification. Although the method allows multi-camera re-identification, it is without a capability for long-term tracking, making it unsuitable for real-time intelligent security applications.

An object of the present disclosure is a system and method that tracks individuals across multiple cameras and over extended periods. There is a need for a system that can manage memory efficiently and share data across camera streams to maintain consistent identification of a person.

### SUMMARY

In an exemplary embodiment, a system for tracking individual persons across a plurality of cameras and over extended periods is disclosed. The system includes the plurality of cameras. The system further includes event streaming processing circuitry configured to receive continuous streams of data from the plurality of cameras, including a plurality of image frames, and output a plurality of short-term person IDs assigned to persons in a field of view of a camera of the plurality of cameras. The system further includes a server configured with one or more artificial intelligence (AI) based models for person detection and embedding vector extraction to obtain person bounding box images and person embedding vectors from the plurality of image frames. The system further includes application processing circuitry configured with an Embedding Manager and an ID Manager. The Embedding Manager maintains a collection of distinct embedding vectors for each of a plurality of persons. The ID Manager is configured to map the plurality of short-term person IDs for a person to respective long-term IDs. The ID Manager associates the person to a unique long-term ID across the plurality of cameras. The system further includes a Tensor Database system for maintaining the extracted embedding vectors. The system further includes an output device configured to track the person appearing across the plurality of cameras based on the unique long-term ID.

In another exemplary embodiment, a method for tracking individual persons across a plurality of cameras and over extended periods is disclosed. The method includes receiving continuous streams of data from the plurality of cameras, including a plurality of image frames, and output a plurality of short-term person IDs assigned to persons in a field of view of a camera of the plurality of cameras. The method further includes performing, by a server configured with one or more artificial intelligence (AI) based models, person detection and embedding vector extraction to obtain person bounding box images and person embedding vectors from the plurality of image frames. The method further includes maintaining, by an Embedding Manager, a collection of distinct embedding vectors for each of a plurality of persons. The method further includes mapping, by an ID Manager, the plurality of short-term person IDs for a person to respective long-term IDs. The method further includes associating, by the ID Manager, the person to a unique long-term ID across the plurality of cameras. The method further includes tracking the person appearing across the plurality of cameras based on the unique long-term ID.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A illustrates a block diagram of a system for person re-identification across a plurality of cameras, in accordance with an exemplary aspect of the disclosure.

FIG. 1B illustrates a high-level diagram of the system for an on-premises or a cloud-based implementation, according to certain embodiments.

FIG. 1C illustrates a block diagram of an event streaming processing circuitry of the system, according to certain embodiments.

FIG. 1D illustrates a block diagram of a model unit of the system, according to certain embodiments.

FIG. 2A illustrates a use case scenario for an Embedding Manager of the system, according to certain embodiments.

FIG. 2B illustrates a block diagram of sub-units of the Embedding Manager, according to certain embodiments.

FIG. 2C illustrates a flow diagram of a process for an Embedding Manager Sub-Unit 2 (EM-SU2), according to certain embodiments.

FIG. 3 illustrates an ID manager of the system, according to certain embodiments.

FIG. 4 illustrates a flowchart of a method for tracking individual persons across the plurality of cameras and over extended periods, according to certain embodiments.

FIG. 5 illustrates a schematic diagram of a multi-camera system with cloud-integrated person tracking and identification, according to certain embodiments.

FIG. 6 is an illustration of a non-limiting example of details of computing hardware used in the computing system, according to certain embodiments.

FIG. 7 is an exemplary schematic diagram of a data processing system used within the computing system, according to certain embodiments.

FIG. 8 is an exemplary schematic diagram of a processor used with the computing system, according to certain embodiments.

FIG. 9 is an illustration of a non-limiting example of distributed components which may share processing with the controller, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Aspects of this disclosure are directed to a system and a method for real-time person re-identification across multiple cameras, enabling consistent and reliable tracking of individuals in dynamic environments such as surveillance, crowd management, and intelligent security systems. Conventional approaches to person re-identification often rely on single-camera tracking methods, lack mechanisms to share identity information across camera streams, and are ineffective at maintaining identity consistency during occlusions or long-term periods.

The present disclosure relates to a system and a method that integrates advanced computer vision techniques and deep learning models to address these limitations. The system includes an event streaming processing circuitry to process real-time data from streams of multiple cameras and uses embedding-based feature extraction to generate unique identity representations (i.e., embedding vectors) for the individuals. Further, the system includes an ID manager that maps short-term IDs from individual cameras to long-term IDs, enabling seamless identity tracking across the multiple cameras and extended timeframes.

Additionally, the system includes a dashboard for real-time monitoring and visualization, facilitating actionable insights for users. The scalability of the system supports efficient handling of increasing number of camera streams and more complex environments. This further ensures improved accuracy in person tracking, minimizes identity reassignment errors, and provides a robust framework for addressing challenges such as occlusions, re-entry tracking, and multi-camera gaps.

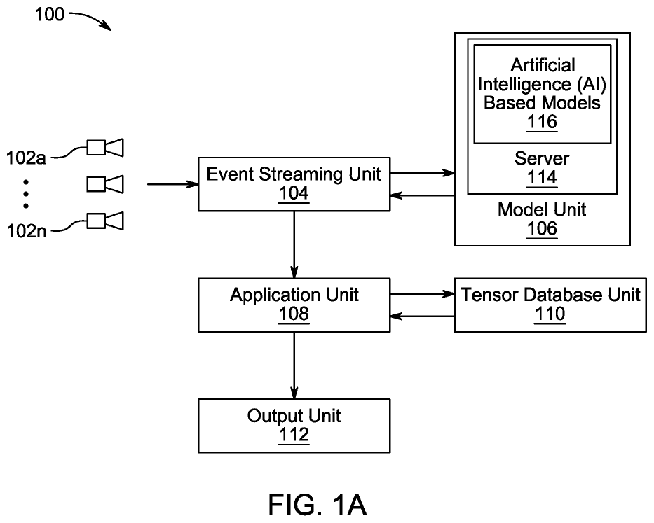

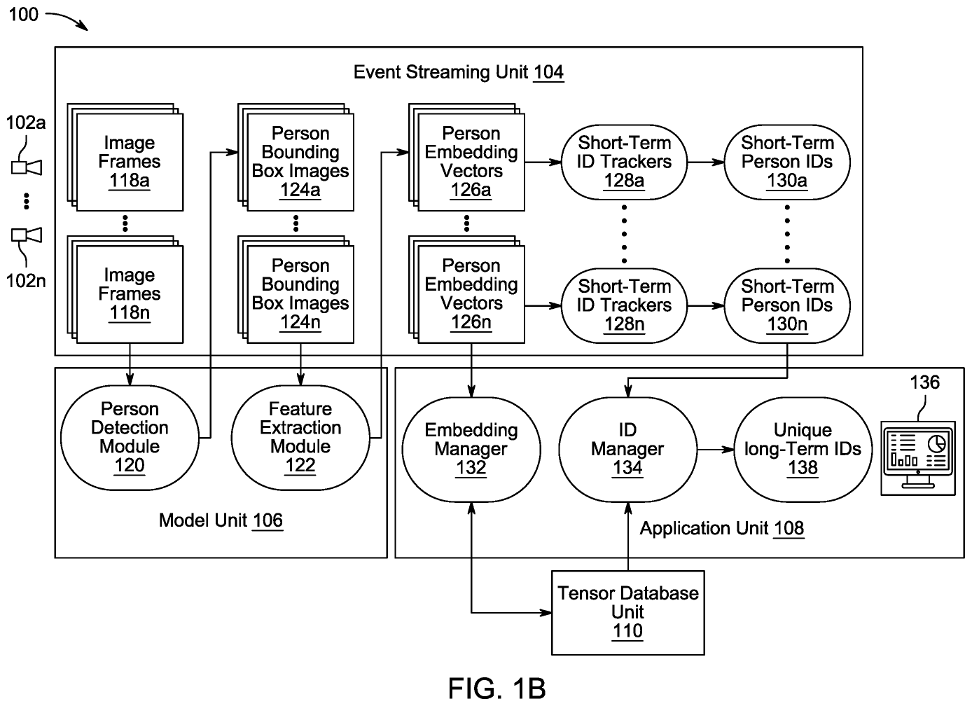

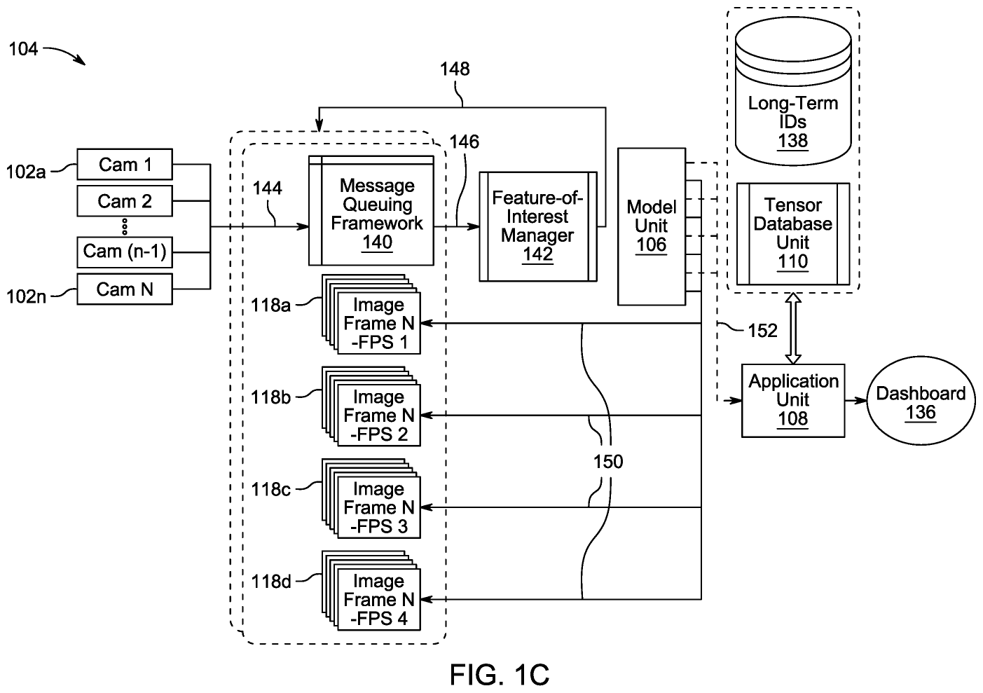

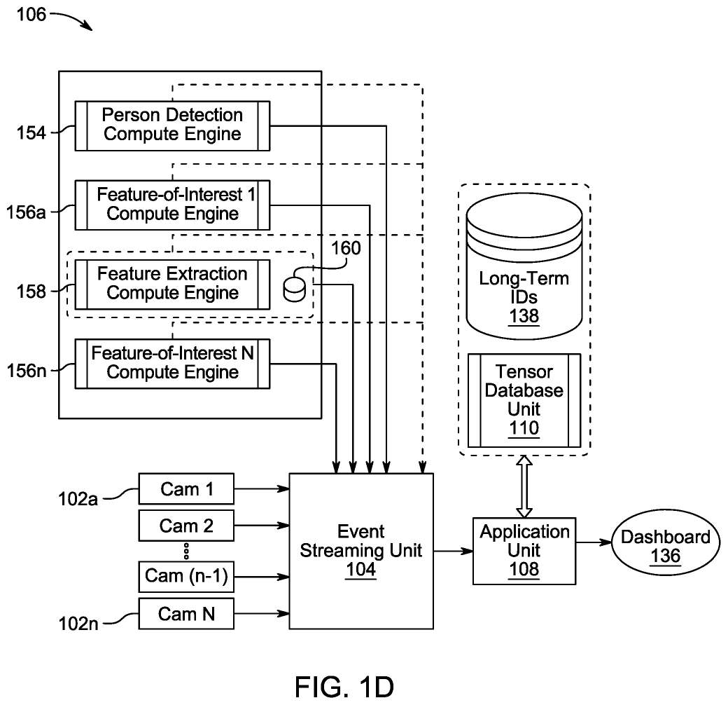

FIG. 1A illustrates a block diagram of a system 100 for person re-identification across a multiple cameras 102a-102n (hereinafter collectively referred to as the cameras 102 and individually referred to as the camera 102), in accordance with an exemplary aspect of the disclosure. As used herein, the term “person re-identification” refers to a process of identifying and tracking individual persons across the multiple cameras 102 or different video frames, even if the appearance or position of an individual person changes over time. The system 100 is configured to detect, track and identify the individual persons (hereinafter collectively referred to as the persons and individually referred to as the person) across the cameras 102 in a unified and continuous manner. The system 100 is also configured to combine data from multiple video feeds to ensure each person is uniquely recognized and tracked as the person moves through different views of the camera 102.

The system 100 includes the cameras 102, an event streaming processing circuitry 104, a model unit 106, an application processing circuitry 108, a Tensor Database system 110 and an output device 112.

In an embodiment, location of the cameras 102 may vary depending on a requirement of an application. For example, in a fixed surveillance setup, the cameras 102 may be placed in fixed positions such as entrances, exits, corridors, hallways, parking lots and so forth. In another example, for outdoor wide-angle coverage applications, the cameras 102 may be located on highways, traffic signals, and other fixed locations. In an embodiment, the cameras 102 may be distributed across multiple locations. In another embodiment, the cameras 102 may be located at a central location.

The cameras 102 may be configured to continuously capture the video feeds in a field of view. As used herein, the term “field of view” refers to an area or extent visible through the cameras 102, lens, or sensors at any given time. In an embodiment, the video feeds may include image frames 118a-118n (as shown in FIG. 1B) (hereinafter collectively referred to as the image frames 118 and individually referred to as the image frame 118) that show a surrounding environment, and any person present within the field of view of the corresponding cameras 102.

In an embodiment, each camera 102 may be equipped with or integrated into one or more Artificial Intelligence (AI) based models 116 that allows the camera 102 to detect the persons in the corresponding field of view and generate person bounding box images 124a-124n (as shown in FIG. 1B) and person embedding vectors 126a-126n (as shown in FIG. 1B). As used herein, the term “person bounding box images 124a-124n” represents a location of detected persons within the image frame 118. Also, as used herein, the term “person embedding vectors 126a-126n” refers to a vector representation of unique characteristics of the person, which are extracted from the image frames 118. In an embodiment, the cameras 102 can be integrated with short-term ID trackers 128a-128n (as shown in FIG. 1B) (hereinafter collectively referred to as the short-term ID trackers 128 and individually referred to as the short-term ID tracker 128). In an embodiment, each camera 102 can be paired with the corresponding short-term ID tracker 128 that assigns short-term person IDs 130a-130n (as shown in FIG. 1B) (hereinafter collectively referred to as the short-term IDs 130 and individually referred to as the short-term ID 130) to the detected persons. In an embodiment, the short-term IDs 130 can be considered to include both existing/stored short-term IDs 130 or new short-term IDs 130). The short-term ID 130 is a temporary identifier used within a scope of the camera 102 to distinguish between the different persons. For example, a first camera 102a detects the person and assigns the short-term ID 130 as “123”. If the person is detected again in an nth camera 102n, then the nth camera 102n assigns another short-term person ID 130 as “567” to the same person.

In an embodiment, the cameras 102 may be configured to transmit a continuous stream of data (i.e., raw image frames 118) to the event streaming processing circuitry 104. In another embodiment, the cameras 102 can be configured to transmit the continuous stream of data (i.e., the image frames 118, the person bounding box images 124a-124n, the person embedding vectors 126a-126n and the short-term person IDs 130) to the event streaming processing circuitry 104. The cameras 102 can be configured to transmit the continuous stream of data to the event streaming processing circuitry 104 through transmission protocols. The transmission protocols can include, but are not limited to, Real-Time Streaming Protocols (RTSP), real-time messaging protocols, WebSocket, Hypertext Transfer Protocol (HTTP), and so forth. Embodiments of the present disclosure are intended to include or otherwise cover any transmission protocol, including known related art and/or later developed technologies.

The event streaming processing circuitry 104 is configured to receive the continuous stream of data from the cameras 102. In an embodiment, the continuous stream of data includes the image frames 118, the person bounding box images 124a-124n, the person embedding vectors 126a-126n and the short-term person IDs 130.

In another embodiment, the continuous stream of data includes the raw image frames 118. In such embodiment, the event streaming processing circuitry 104 may be configured to transmit the raw image frames 118 to the model unit 106 for processing through a real-time data stream (e.g., using protocols like WebSocket, HTTP, and message queues).

The model unit 106 may be configured to consume the raw image frames 118 (i.e., video feeds) from the event streaming processing circuitry 104. The model unit 106 includes a server 114 configured with the one or more AI based models 116 for person detection and embedding vector extraction to obtain the person bounding box images 124a-124n and the person embedding vectors 126a-126n from the image frames 118. In an embodiment, the model unit 106 may also be configured to assign the short-term person IDs 130 to the detected persons for tracking the persons over a short time window. In an exemplary embodiment, the short-time window refers to a limited duration of time during which the short-term ID tracker 128 tracks and associates the detected persons across sequential frames in the video feed. The short-time window may be defined based on a frame rate. The model unit 106 may be configured to transmit the person bounding box images 124a-124n, the person embedding vectors 126a-126n, and the short-term person IDs 130 to the event streaming processing circuitry 104.

The event streaming processing circuitry 104 is configured to transmit processed data, including the person embedding vectors 126a-126n and the short-term IDs 130, to the application processing circuitry 108. In an embodiment, the event streaming processing circuitry 104 can be configured to transmit the processed data to the application processing circuitry 108 in a continuous and real-time manner through a real-time streaming mechanism. The real-time streaming mechanism can include, but is not limited to, a Message Queuing Systems (MQS) (e.g., Kafka, RabbitMQ), a Representational State Transfer Application Programming Interface (RESTful APIs), streaming protocols (e.g., Message Queuing Telemetry Transport (MQTT), RTSP), and so forth. Embodiments of the present disclosure are intended to include or otherwise cover any real-time streaming mechanism, including known related art and/or later developed technologies.

The application processing circuitry 108 is configured to handle assignments of long-term person IDs 138 (as shown in FIG. 1B) across the cameras 102 and extended periods. In other words, the application processing circuitry 108 ensures that even as the person moves through different views of the camera 102, an identity of the person is maintained consistently over time, and the person is tracked continuously. As used herein, the term “extended periods” can refer to a longer duration of time (i.e., minutes to hours) during which the system 100 tracks the persons across the video feeds of the multiple cameras 102 or over a prolonged period. In an embodiment, the application processing circuitry 108 can act as an interface between the event streaming processing circuitry 104 and the Tensor Database system 110. In other words, the application processing circuitry 108 can be configured to handle a flow of data (i.e., the person embedding vectors 126a-126n and the short-term IDs 130) between the event streaming processing circuitry 104 and the Tensor Database system 110, ensuring that the data from the event streaming processing circuitry 104 is processed, managed and sent to the Tensor Database system 110 for storage and further analysis.

The Tensor Database system 110 can interact with the application processing circuitry 108 to enable efficient management and utilization of the person embedding vectors 126a-126n and associated metadata (e.g., the short-term person IDs 130 and the person bounding box images 124a-124n). In an embodiment, an interaction between the Tensor Database systemt 110 and the application processing circuitry 108 is facilitated through a combination of Application Programming Interfaces (APIs), data pipelines, query mechanisms and other programmed link. The Tensor Database system 110 is configured to maintain the extracted person embedding vectors 126a-126n. In an embodiment, the Tensor Database system 110 can be configured to store the person embedding vectors 126a-126n in an organized structure to support fast retrieval and similarity search. The Tensor Database system 110 can include, but is not limited to, Weaviate, Milvus, Pinecone, Chroma, and other tensor databases. Embodiments of the present disclosure are intended to include or otherwise cover any type of the Tensor Database system 110, including known related art and/or later developed technologies.

The output device 112 is configured to track the person appearing across the multiple cameras 102 based on the long-term ID 138. In an embodiment, the long-term ID 138 can also be considered as new long-term ID 138. In an exemplary embodiment, the output device 112 can be configured to receive the processed data from the application processing circuitry 108. The processed data includes the long-term IDs 138, a location of the person across the cameras 102, and other data about the person. The output device 112 can be configured to transmit the processed data to external systems, such as monitoring systems to visualize or report the movements and activities of the person over time.

For example, suppose the person is detected by the first camera 102a with the short-term ID 130 (e.g., short-term ID A). Upon processing through the application processing circuitry 108, the application processing circuitry 108 assigns the long-term ID 138 (e.g., Long-Term ID A) to the person. As the person moves through a building, the person is detected by a second camera (not shown), a third camera (not shown) and a fourth camera (not shown), all of which capture different perspectives of the person. Despite being detected by different cameras, the output device 112 ensures that these new detections are linked to the Long-Term ID A, enabling the system 100 to track the movements of the persons across multiple areas.

FIG. 1B also represents a high-level diagram of the system 100 for an on-premises or a cloud-based implementation, according to certain embodiments. In an embodiment, the system 100 can be deployed and run on servers. In another embodiment, the system 100 can be hosted on an infrastructure owned and managed by an organization. In yet another embodiment, the system 100 can be hosted on cloud platforms (e.g., Azure™, Amazon Web Services (AWS)™).

Referring back to FIG. 1B, the system 100 includes the event streaming processing circuitry 104 configured to receive the continuous stream of data from the cameras 102. In an embodiment, the continuous stream of data includes the image frames 118, the person bounding box images 124a-124n, the person embedding vectors 126a-126n and the short-term person IDs 130. In an embodiment, the embedding vectors 126 are referred to as existing or previous embedding vectors 126 stored in the Tensor Database system 110 and new embedding vectors 126. In an embodiment, the event streaming processing circuitry 104 is configured to transmit the image frames 118 received from the corresponding cameras 102 to the model unit 106.

The model unit 106 includes a person detection module 120 and a feature extraction module 122. The person detection module 120 is configured to identify the persons in each image frame 118 using a detection algorithm. The detection algorithm can be a Convolutional Neural Network (CNN) such as, but not limited to, You Only Look Once (YOLO) based AI detection model (e.g., YOLO v8), Faster Region-Convolutional Neural Network (R-CNN), Single Shot Multi-Box Detector (SSD), and other vision systems. Embodiments of the present disclosure are intended to include or otherwise cover any detection algorithm, including known related art and/or later developed technologies.

In an exemplary embodiment, the person detection module 120 may use the detection algorithm to extract spatial features (e.g., bounding box coordinates, size and shape of the person, a distance between the persons) and semantic features (e.g., person identity, person activity) from the image frames 118. The extracted spatial and semantic features help the person detection module 120 to recognize patterns that represent characteristics of the persons, such as body shapes or textures. The person detection module 120 further identifies regions in the image frame 118 where the person may be present and marks the identified regions with bounding boxes defined by rectangular coordinates. In an embodiment, each bounding box is assigned a confidence score that indicates a likelihood of the detected person. The person detection module 120 can be configured to generate a person detection output consisting of the bounding box images 124 (i.e., precise bounding boxes for each detected person in the image frame 118). The person detection module 120 of the model unit 106 is configured to transmit a final output (i.e., the bounding box images 124) to the event streaming processing circuitry 104.

The event streaming processing circuitry 104 is further configured to transmit the person detection output (i.e., bounding box images 124) to the feature extraction module 122 of the model unit 106. The feature extraction module 122 is configured to extract a set of features from each bounding box image 124 based on the appearance of the person (e.g., color texture, deep bodily features of the person) using person re-identification AI models. The person re-identification AI models can be deep neural networks such as, but not limited to, Transformer-based object re-identification (TransReID), and so forth. In an exemplary embodiment, the deep neural network processes the bounding box images 124 through layers of a neural network for extracting low-level features like edges and textures in early layers and high-level semantic features like body shape and clothing patterns in deeper layers.

The feature extraction module 122 can be configured to aggregate the extracted features into a single vector representation using techniques such as, but not limited to, a global average pooling, fully connected layers and image filters. In an embodiment, a final layer of the deep neural network (model) generates a feature extraction output (i.e., the embedding vectors 126). The embedding vector 126 is a fixed length numerical representation that encodes unique characteristics of the person in the bounding box images 124. The feature extraction module 122 can be configured to transmit the feature extraction output (i.e., the embedding vectors 126) to the event streaming processing circuitry 104.

The event streaming processing circuitry 104 includes the short-term ID trackers 128 for the corresponding cameras 102 for assigning the short-term person IDs 130 to the person in the field of view of the respective camera 102. In an embodiment, the short-term ID trackers 128 use the feature extraction output, which consists of the embedding vectors 126 generated for each detected person. In such embodiment, the short-term ID trackers 128 associate and track the persons by comparing a similarity of the embedding vectors 126 across consecutive image frames 118. For example, when the person reappears in a next image frame, the short-term ID tracker 128 can check if the embedding vector 126 of the next image frame closely matches any of previously tracked embedding vectors 126. If the match is found, the short-term ID tracker 128 assigns the same short-term ID 130 to the person. If no match exists, then a new short-term ID 130 is assigned. The short-term ID tracker 128 outputs the short-term person IDs 130 along with updated vector embeddings 126 and the bounding box images 124 for further processing. The event streaming processing circuitry 104 is configured to transmit the processed data, including the embedding vectors 126 and the short-term IDs 130, to the application processing circuitry 108.

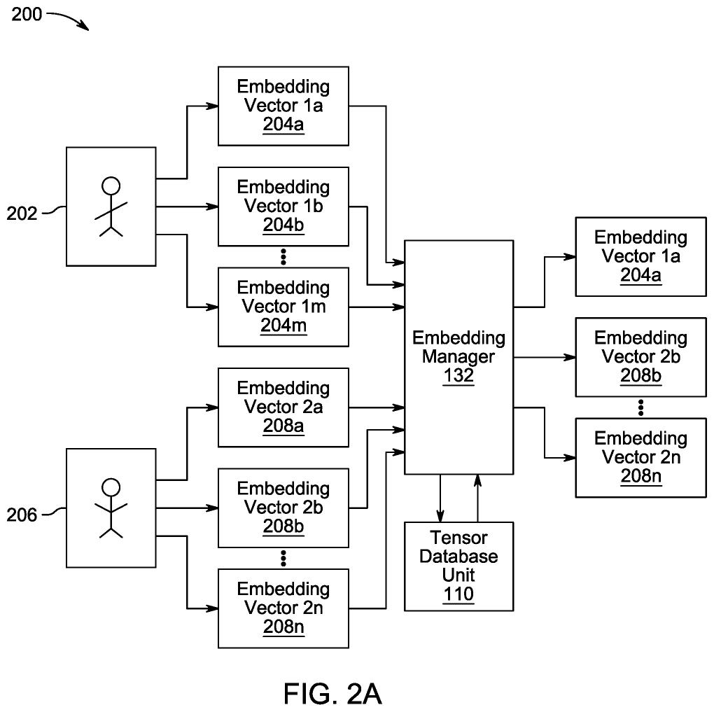

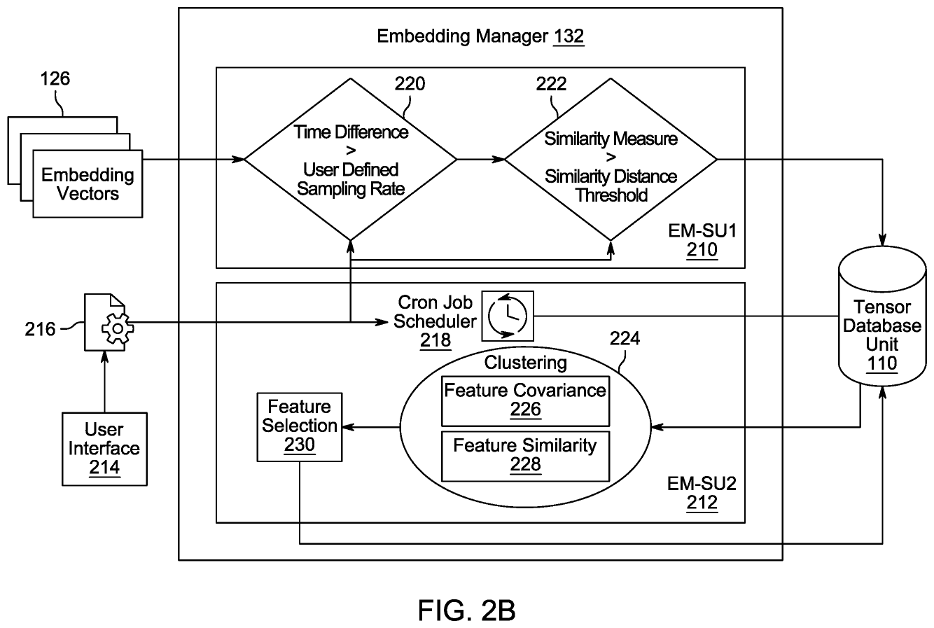

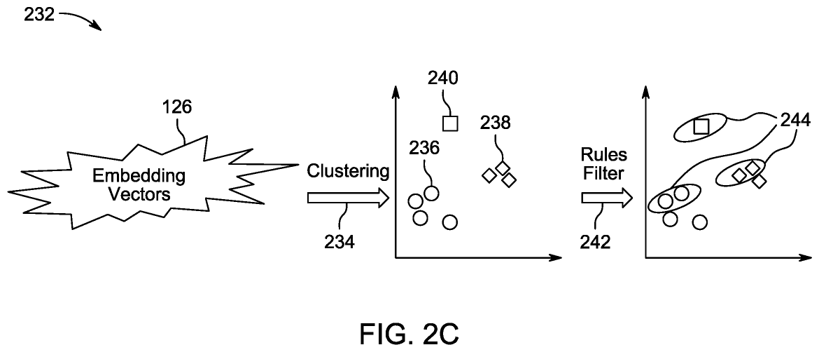

The application processing circuitry 108 is configured with an Embedding Manager 132, an ID Manager 134 and a dashboard 136. The Embedding Manager 132 is configured to consume the embedding vectors 126 from incoming data streams (i.e., the processed data). The Embedding Manager 132 maintains a collection of distinct embedding vectors for each of the persons. In an embodiment, the Embedding Manager 132 performs pre-processing, such as filtering redundant or low-quality embedding vectors 244 (as shown in FIG. 2C), before storing or utilizing the embedding vectors 126. Further, the Embedding Manager 132 can be configured to synchronize the embedding vectors 126 with the Tensor Database system 110. In an embodiment, functionality and sub-units of the Embedding Manager 132 is explained in detail in conjunction with FIG. 2B and FIG. 2C.

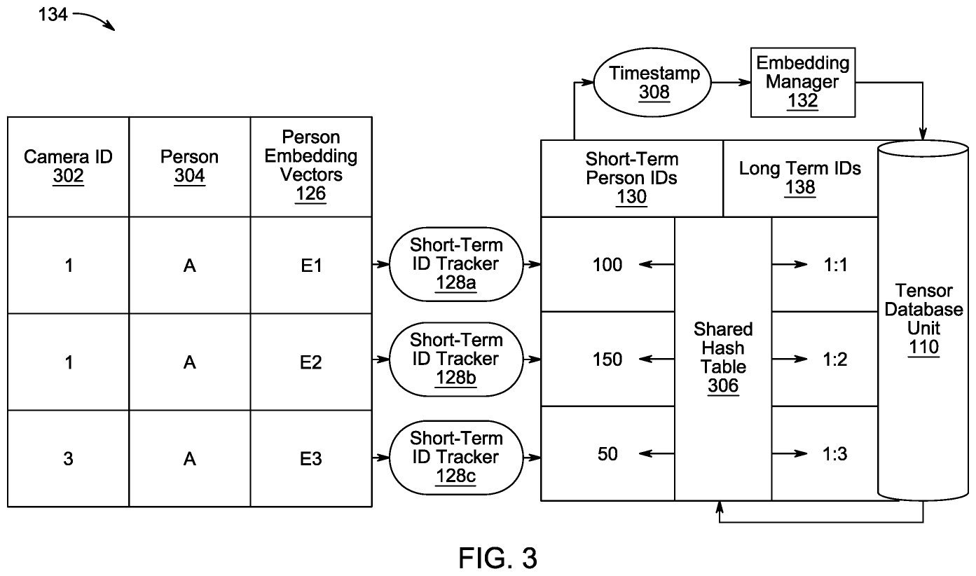

The ID Manager 134 is configured to consume the short-term IDs 130 from the incoming data stream (i.e., the processed data). The ID Manager 134 maps the short-term IDs 130 to the respective long-term IDs 138. The ID Manager 134 associates the person with the unique long-term IDs 138 across the cameras 102. In an embodiment, a process of mapping the short-term IDs 130 to the respective long-term IDs 138 is explained in conjunction with FIG. 3.

The dashboard 136 in the application processing circuitry 108 serves as a central interface for monitoring and visualizing the long-term tracking of the persons across the cameras 102 based on the long-term IDs 138. The dashboard 136 is configured to provide an interface for users to monitor the tracking of the persons across the cameras 102, view their movements and analyze system performance metrics such as person detection efficiency and the activity of the short-term ID tracker 128. The dashboard 136 can also be configured to generate alerts for specific events, such as unauthorized access or reappearance of the persons, and offers tools for configuring system parameters like embedding similarity thresholds, feature extraction sampling rates, and scheduling database updates.

FIG. 1C illustrates a block diagram of the event streaming processing circuitry 104 of the system 100, according to certain embodiments. Referring to FIG. 1C, a flow of data from the multiple cameras 102 to various processing components, including a message queuing framework 140, Feature-of-Interest (FoI) manager 142 and their interaction with downstream processing circuitry such as the model unit 106 and the application processing circuitry 108, is depicted. The model unit 106 contains AI models configured as FoI detectors.

The FoI Manager 142 provides an interface to the end user, where user can input the use-cases for each camera. Based on the user configuration, the job of FoI Manager 142 is to call particular FoI Detectors from the Model Unit 106 and link it to the corresponding Message Queuing Framework 140 (the relevant video stream).

At step 144, the event streaming processing circuitry 104 receives the image frames 118a to 118d from multiple frame sources such as the RTSP, the cameras 102, and video streams. Embodiments of the present disclosure are intended to include or otherwise cover any frame source, including known related art and/or later developed frame sources. The image frames 118 are streamed into the message queuing framework 140, such as, but not limited to, Kafka, Rabbit Message Queue (MQ), Amazon Simple Queue Service (SQS), and ActiveMQ. The message queuing framework 140 acts as a buffer and an organizer for the image frames 118, ensuring efficient handling of large volumes of data (i.e., image frames 118). In an embodiment, the message queuing framework 140 organizes and manages the received image frames 118 by applying a specific Frames-Per-Second (FPS) rate, ensuring smooth and efficient data flow.

At step 146, FoI detectors can be dynamically configured in FoI manager block 142, for example including configuration by an end user.

FoI manager 142 is used to manage FoI detectors. The Model Unit 106 contains a collection of AI models configured as FoI detectors. The FoI manager 142 decides:
(1) The list of AI models to be invoked and executed (based on input from the user),
(2) Assignment of the image FPS queue to the corresponding AI model, and
(3) Spawn new AI model instances based on GPU consumption/load.

As an example, regarding (1) the list of AI models to be invoked, assume the end user/client needs people counting on camera 1 and gender detection on camera 2. The user inputs this information to the FoI manager 142. Now the FoI manager understands that person detection AI model, person reidentification AI model and person gender detection AI models need to be invoked.

As per the example, regarding (2), people counting may require a higher frame processing rate for higher accuracy. So the FoI manager 142 assigns a higher FPS image (20 fps for example) queue to person detection AI model.

However, gender detection does not require high FPS. So the FoI manager 142 can assign the gender detection AI model to a lower FPS image queue (fps for example). This means, for the people counting use case on camera1, the relevant AI models receive the image queue with 20 fps and for the gender detection use case on camera2, the relevant AI models receive image queue with 5 fps.

As per the example, regarding (3), when the Model Unit 106 is overloaded with too many person detections, high number of cameras, etc, FoI manager 142 can spawn additional models to share the load. Alternatively, when the load on the Model Unit 106 becomes lower, FoI manager 142 can reduce the number of FoI detectors.

Each FoI detector then processes the image frames 118 based on the FPS rate and extracts features of interest (FoI) such as the persons, objects, and the events. The FoI detector dynamic configuration allows for dynamic scaling, ensuring that an increased number of FoI detectors are supported for real-time processing. For example, if a particular store experiences high traffic, the system 100 can activate additional FoI detectors to handle increased data load efficiently.

At step 148, as the number of FoI detectors increases (e.g., more people detected in the image frames 118 of the corresponding cameras 102), the message queueing framework 140 and FOI detectors 156a-156n (i.e., compute resources) (as shown in FIG. 1D) are automatically scaled to maintain processing efficiency. For example, if more people are detected in a scene, the FoI manager 142 dynamically allocates additional resources to handle an increased computational demand for person detection and processing. In a similar manner, when the FoI manager 142 detects that the number of FoI detectors decreases, the FoI manager 142 automatically reduces the number of FoI detectors to a number necessary to meet the computational demand.

At step 150, the image frames 118, assigned by the FoI manager 142, are processed by the model unit 106. The model unit 106 generates output, including the bounding box images 124, the embedding vectors 126, and the short-term person IDs 130, which are transmitted to the event streaming processing circuitry 104. The model unit 106 is configured to transmit the output in the form of a payload to the event streaming processing circuitry 104. In an embodiment, the payload undergoes further computation, such as applying filtering, aggregating, or even invoking other models that refine the output. In an embodiment, the event streaming processing circuitry 104 is configured to overlay the output (e.g., the bounding box images 124, the embedding vectors 126 and the short-term IDs 130) onto the original image frames 118. For example, the payload (e.g., the short-term ID 130) is linked with a specific portion of the image frames 118 (e.g., a bounding box around the person). The overlay can visually represent the output of the model unit 106 (e.g., a box around the detected person with their short-term ID 130) to make data more interpretable. In another embodiment, the event streaming processing circuitry 104 is configured to compile the output for further processing. The compile data refers to a process of organizing, associating and preparing the output generated by the model unit 106 in a structured manner for further processing.

At step 152, the event streaming processing circuitry 104 or the model unit 106 can be configured to transmit the compiled data to the application processing circuitry 108, where the compiled data is processed further for long-term tracking in the application processing circuitry 108, storage in the Tensor Database system 110 or visualization on the dashboard 136.

FIG. 1D illustrates a block diagram of the model unit 106 of the system 100, according to certain embodiments. The model unit 106 may be configured to perform computations on the image frames 118 (as shown in FIG. 1C) received from the cameras 102 and extract meaningful information such as detect the persons. The model unit 106 includes FoI detectors 156a-156n (hereinafter referred to as FoI compute engine 156) which can consist of multiple FoI compute engines, such as a “person detection” compute engine 154, “person ethnicity” compute engine, “person action recognition” compute engine, “person gaze” compute engine and a feature extraction compute engine 158. The FoI compute engine 156 can be used by end users in accordance with features that are of interest to an end user.

In an embodiment, the person detection compute engine 154 uses pre-trained models (e.g., deep learning models like YOLO) to analyze the image frames 118 and detect the persons. The person detection compute engine 154 can be configured to generate the output that includes bounding box images 124 (as shown in FIG. 1B) using the pre-trained models. The person detection compute engine 154 can be configured to transmit the output to the feature extraction compute engine 158.

Further, the FoI compute engine 156 can be a specialized AI based model 116 designed to detect specific FoIs in the image frames 118. The AI based model 116 is adaptable and can be activated or deactivated based on specific person detection requirements. The FoI compute engine 156 integrates the AI-based model 116 corresponding to the FoI detectors 142, which are trained to identify various objects, actions, or attributes that the system 100 is configured to identify.

For example, the FoI 1 compute engine 156a is a gender recognition model that can be activated to detect gender of the persons in the image frames 118. Similarly, the FoI N compute engine 156n is an action recognition model that can be activated to identify actions like “running”, “walking”, “fighting” and other movement.

In an embodiment, FoI computer engines can be selected by an end user in a configuration user interface of the FoI manager 142. The ability to turn the AI based models 116 ON or OFF provides flexibility to focus on relevant detections and optimize computational resources. For instance, if the end user decides that gender recognition is unnecessary for a particular use case, then the corresponding AI-based model 116 may be deactivated, releasing the computational resources for other tasks like action recognition or person detection.

In an embodiment, the FoI detectors are modular, as the FoI detectors can be removed or added based on the requirement. The FoI detectors can run in parallel, consuming the image frames 118 from the message queuing framework 140 and providing the FoIs of the image frames 118 to the model unit 106, which further processes the detected FoIs.

In an embodiment, as the load of the FoI detectors increases (e.g., when more people are detected), the model unit 106 is configured to scale up instances of the respective compute engines (e.g., spawn more instances of FoI compute engine 156 or the feature extraction compute engine 158). Conversely, if fewer FoI detectors are detected, the FoI manager 142 can be configured to scale down the instances of the respective compute engines (e.g., less instances of the FoI compute engine 156 or the feature extraction compute engine 158). This dynamic scaling ensures that the system 100 remains efficient and responsive, regardless of the workload.

The feature extraction compute engine 158 processes the output received from the person detection computing engine 154 and the FOI compute engine 156 to generate the embedding vectors 126. The feature extraction compute engine 158 is configured to store the generated embedding vectors 126 in a local embedding storage 160.

The local embedding storage 160 is configured to temporarily store the embedding vectors 126 generated by the feature extraction compute engine 158. The local embedding storage 160 allows for efficient access to the embedding vectors 126 when needed, especially for tasks such as short-term tracking. By storing the embedding vectors 126 locally, the system 100 may compare new person detections against previous person detections to track the same person across different image frames 118. Moreover, the embedding vectors 126 can be used to identify the same person even if they appear in different locations or at different times.

Once the model unit 106 processes the image frames 118 and extracts the features (such as bounding box images 124, the short-term IDs 130, and the embedding vectors 126) by using the person detection compute engine 154, the FoI compute engine 156 and the feature extraction compute engine 158, the model unit 106 then generates a message payload containing processed data. The message payload is then published to the event streaming processing circuitry 104. The event streaming processing circuitry 104 acts as a message broker and delivers the processed data to the application processing circuitry 108 and the dashboard 136 for further processing and real-time monitoring.

Consider an example surveillance system 100 deployed in a shopping mall with 5 cameras. The system 100 is configured to track various people and recognize certain actions, such as “loitering” or “running.” In such a scenario, the model unit 106 scales dynamically as the number of detected persons increases. If more persons enter the shopping mall, the model unit 106 increases its processing power by activating additional instances of the person detection compute engine 154 or the relevant FoI compute engine 156 (e.g., activating the action recognition model or the gender recognition model).

The gender recognition model and the action recognition model may be turned ON, while an unnecessary age recognition model is turned OFF to save the computational resources. Each of the 5 cameras has its respective short-term tracker, ensuring independent tracking of the persons across different camera views. The processed data from the model unit 106, including the bounding box images 124, the short-term IDs 130, and the embedding vectors 126, is encapsulated into the message payload. The message payload is then subscribed to and processed by the event streaming processing circuitry 104, enabling further analysis or real-time visualization.

FIG. 2A illustrates a use case scenario 200 for the Embedding Manager 132 of the system 100, according to certain embodiments. The Embedding Manager 132 acts as a quality control mechanism to manage and refine the embedding vectors 126 (as shown in FIG. 1B) associated with each individual. The Embedding Manager 132 is configured to discard redundant embedding vectors 244 (i.e., the embedding vectors 244 that do not add new information) (as shown in FIG. 2C) and retain distinct embedding vectors for better person identification. In an exemplary scenario, suppose a first person 202 has m embedding vectors 204a-204m (hereinafter referred to as the m embedding vectors 204) and a second person 206 has n embedding vectors 208a-208n (hereinafter referred to as the n embedding vectors 208) stored in the Tensor Database system 110. The Embedding Manager 132 analyzes the m embedding vectors 204 for the first person 202 and the n embedding vectors 208 for the second person 206. For the first person 202, the Embedding Manager 132 identifies that most of the embedding vectors are repetitive and selects an embedding vector 1a 204a (i.e., a distinct embedding vector) to represent a collection of the redundant embedding vectors associated with the first person 202. For the second person 206, the Embedding Manager 132 identifies variations across the n embedding vectors 208 and selects an embedding vector 2b 208b and an embedding vector 2n 208n (distinct embeddings) to capture their range of appearances. By discarding the redundant embedding vectors 244 and retaining the distinct embedding vectors, the Embedding Manager 132 optimizes memory usage, improves computational efficiency and enhances person re-identification accuracy by maintaining a more representative set of features for each individual.

FIG. 2B illustrates a block diagram of sub-units of the Embedding Manager 132, according to certain embodiments. The Embedding Manager 132 includes an Embedding Manager Sub-Unit 1 (EM-SU1) 210 and an Embedding Manager Sub-Unit 2 (EM-SU2) 212. The EM-SU1 210 operates in real-time to filter and store the embedding vectors 126 based on user-defined configuration parameters. The Embedding Manager 132 includes a user interface 214 for system administrators to input the user-defined configuration parameters, such as a user-defined sampling rate of time difference between adjacent embedding vectors 126 corresponding to the short-term ID 130 (as shown in FIG. 1B) and a similarity distance threshold as a required measure between an existing embedding vector 126 (as shown in FIG. 1B) in the Tensor Database system 110 and the new embedding vector 126 (as shown in FIG. 2B).

The EM-SU1 210 includes a configuration module 216 that stores the user-defined configuration parameters. The configuration module 216 can also interact with a cron job scheduler 218 to manage scheduled tasks. The cron job scheduler 218 executes the scheduled tasks such as maintaining the Tensor Database system 110. In an exemplary embodiment, the scheduled tasks include cleaning outdated embedding vectors 126, resetting the Tensor Database system 110, scheduling clustering jobs, and other tasks.

FIG. 2B illustrates a functionality of the EM-SU1 210 as a step-by-step process for managing the embedding vectors 126 in real-time. The process begins with receiving the embedding vectors 126 corresponding to the short-term person IDs 130. The embedding vectors 126 are evaluated based on the user-defined configuration parameters before being stored in the Tensor Database system 110. In an embodiment, the embedding vector 126 is received from upstream modules, such as the event streaming processing circuitry 104.

Further, the process includes step 220 of comparing timestamp 308 (as shown in FIG. 3) of the received (new) embedding vector 126 with the most recent timestamp of the embedding vector 126 that is stored in the Tensor Database system 110 for the same short-term ID 130. In an embodiment, if a time difference between the timestamp 308 of the received embedding vector 126 and the most recent timestamp of the stored embedding vector 126 is less than the user-defined sampling rate, then the received embedding vector 126 is discarded. In another embodiment, if the time difference between the timestamp 308 of the received embedding vector 126 and the most recent timestamp of the stored embedding vector 126 is greater than the user-defined sampling rate, then the received embedding vector 126 is forwarded to step 222 for similarity check.

For example, if the short-term ID 130 is 100, the sampling rate is 2 seconds (configured by the user), incoming embedding vectors 126 are E1, E2, E3, E4 and E5 and the timestamps 308 of E1 is 1727181982, E2 is 1727181983, E3 is 1727181984, E4 is 1727181985 and E5 is 1727181986. During the evaluation of the embedding vector 126 (E1), it is observed that no previous embedding vector 126 for the short-term ID 130 (i.e., 100) is available in the Tensor Database system 110. Therefore, the embedding vector 126 (i.e., E1) is added to the Tensor Database system 110.

For the embedding vector 126 (E2): the time difference is 1727181983−1727181982=1 second, which is less than 2 seconds (i.e., the sampling rate), so, the embedding vector 126 (E2) is discarded.

For the embedding vector 126 (E3), the time difference is 1727181984−1727181982=2 seconds. Therefore, the embedding vector 126 (E3) is discarded.

For the embedding vector 126 (E4): the time difference is 1727181985−1727181982=3 seconds, which is greater than 2 seconds and meets sampling rate criteria. Therefore, the embedding vector 126 (E4) is transmitted for the similarity check.

For the embedding vector 126 (E5), the time difference is 1727181986−1727181985=1 second, which is less than the sampling rate. Therefore, the embedding vector 126 (E5) is discarded. In this example, E1 and E4 are forwarded to step 222 for the similarity check.

At step 222, a similarity measure is computed for the embedding vectors 126 that pass the sampling rate evaluation. The similarity measure is computed between the embedding vectors 126 that pass the sampling rate evaluation and a latest embedding vector 126 that is stored in the Tensor Database system 110. Further, the computed similarity measure is compared with the user-defined similarity distance threshold. In an embodiment, if the computed similarity measure is less than the user-defined similarity distance threshold, then the corresponding received embedding vectors 126 are discarded. In another embodiment, if the computed similarity measure is above the user-defined similarity distance threshold, then the corresponding embedding vectors 126 are stored in the Tensor Database system 110. For example, the similarity distance threshold is 0.8 and the stored embedding vector 126 for the short-term ID 130 (i.e., 100) is E1: [0.2, 0.5, 0.8]. Also, the received embedding vectors 126 for the short-term ID 130 (i.e., 100) are E4: [0.21, 0.52, 0.81]. During the evaluation, the similarity measure is computed between E1 and E4, producing a similarity measure of 0.95, which is greater than the similarity rate threshold (0.8). Therefore, E4 is stored in the Tensor Database systemt 110 as it provides distinct information. Here, the embedding vectors 126 that are stored in the Tensor Database system 110 are E1 and E4 (distinct embeddings).

The EM-SU2 212 is configured as a background process to cluster the embedding vectors 126. The EM-SU2 212 is configured to execute scheduled jobs that can be configured by the user using the user interface 214. The EM-SU2 212 is configured to execute scheduled jobs for managing the Tensor Database system 110. For example, the execution of scheduled jobs includes clearing the Tensor Database system 110 at 12 a.m. every day for calculating daily people counts.

In an embodiment, the EM-SU2 212 performs a process of clustering 224 by using clustering methods to cluster the embedding vectors 126 received from the Tensor Database system 110 in order to manage outlier embedding vectors 244 and discard the embedding vectors 244 that are grouped together based on the similarity distance threshold. In an embodiment, the EM-SU2 212 analyzes feature covariance 226 to identify features of the embedding vector 126 that are highly correlated. The features with a high covariance indicate redundancy and such features can be discarded during clustering 224 to reduce noise and improve the efficiency of a clustering process. Additionally, the EM-SU2 212 evaluates feature similarity 228 to assess how close the embedding vectors 126 are to one another. The feature similarity 228 quantifies a resemblance between the embedding vectors 126 based on the selected features, using measures such as cosine similarity. The feature similarity 228 evaluation helps in grouping the embedding vectors 126 that are highly similar into clusters while identifying the embedding vectors 244 (as shown in FIG. 2C) that are sufficiently different as outliers. By using the feature covariance 226 and the feature similarity 228, the EM-SU2 212 ensures that only meaningful and distinct embedding vectors are retained.

The EM-SU2 212 further initiates a process of feature selection 230, where the most relevant and distinguishing features of the embedding vectors 126 are identified and retained for further processing. In an embodiment, the features of the embedding vectors 126 are identified using various techniques such as, but not limited to, feature importance ranking, correlation analysis, clustering relevance, dimensionality reduction techniques, threshold-based selection and so forth. The feature selection 230 ensures that only essential features that contribute significantly to a re-identification task are preserved while redundant and less informative features are discarded. Further, the EM-SU2 212 outputs the refined embedding vectors 126 to the Tensor Database system 110 to update the stored embedding vectors 126 in the Tensor Database unit 110.

FIG. 2C illustrates a flow diagram of a process 232 for the EM-SU2 212, according to certain embodiments.

At step 234, the process 232 includes clustering 224 (as shown in FIG. 2B) the embedding vectors 126 that are stored in the Tensor Database system 110. The embedding vectors 126 are clustered based on the similarity distance threshold. Here, the embedding vectors 126 are plotted on a graph, where points of similar types represent groups of embedding vectors 126 with high similarity. For example, a first group 236 corresponds to the embedding vectors of one individual, a second group 238 corresponds to the embedding vectors of a second individual, and a third group 240 corresponds to an embedding vector of a third individual.

At step 242, the process 232 includes applying a rule filtering on the clusters of the embedding vectors 126 to discard the redundant or outlier embedding vectors 244 from each group (e.g., the first group 236, the second group 238 and the third group 240). Here, the redundant or outliers embedding vectors 244 are circled and marked as discarded. In an exemplary embodiment, the rule filtering utilizes a cosine similarity approach where a pairwise similarity between the embedding vectors within the clusters is computed. If two embedding vectors are very similar (e.g., similarity >0.95), then one of the embedding vectors 244 from the corresponding clusters, can be considered redundant and discarded. In another exemplary embodiment, the rule filtering utilizes a distance threshold approach where a distance threshold is set within which the embedding vectors are considered redundant. If the two embedding vectors from the corresponding clusters fall within the distance threshold, then one of the embedding vectors 244 is discarded.

FIG. 3 illustrates the ID Manager 134 of the system 100, according to certain embodiments. The ID Manager 134 maintains a shared hash table 306 that maps the short-term IDs 130 and a respective long-term ID 138. As used herein, the “shared hash table 306” refers to a synchronized data structure that maps the short-term IDs 130 (temporary identifiers) to the long-term IDs 138 (unique, consistent identifiers). The shared hash table 306 allows different components (e.g., the short-term ID trackers 128a-128c, the ID Manager 134, and the Tensor Database system 110) to access, modify and retrieve a mapping of the short-term IDs 130 to the long-term IDs 138 in real-time. The shared hash table 306 is central to tracking and maintaining associations between the short-term IDs 130 and the long-term IDs 138 across the cameras 102 and the embedding vectors 126. For example, as shown in FIG. 3, the ID Manager 134 is maintaining the shared hash table 306 that maps the short-term IDs 130 (e.g., 100, 150 and 50) and the corresponding long-term ID 138 (e.g., 1). In an embodiment, a collection of the embedding vectors 126 may be associated with every long-term ID 138, where each entry follows a format such as
<long-term ID 138>:<entry id>

Further, the ID Manager 134 synchronizes with the Tensor Database system 110 to assign the respective long-term IDs 138 to the corresponding embedding vectors 126 (processed by the Embedding Manager 132 and stored in the Tensor Database system 110) and maintains this mapping information within the shared hash table 306.

For example, a person 304 (i.e., Person A) appears in camera IDs 302 (e.g., 1 and 3), resulting in multiple short-term IDs 130 (e.g., 100, 150, 50). The Embedding Manager 132 processes the embedding vectors 126 corresponding to the multiple short-term IDs 130 and identifies that the multiple short-term IDs 130 represent the same person 304 (i.e., Person A). Upon processing the embedding vectors 126 for the multiple short-term IDs 130, the Embedding Manager 132 stores the processed embedding vectors 126 in the Tensor Database system 110. The ID Manager 134 then assigns the long-term ID 138 (e.g., 1) to the embedding vectors 126 corresponding to the multiple short-term IDs 130, as the multiple short-term IDs 130 represent the same person 304 (i.e., person A). The mapping between the short-term IDs 130 and the long-term ID 138 is maintained in the shared hash table 306. The ID Manager 134 ensures that the person 304 (i.e., Person A) is assigned the unique long-term ID 138 (e.g., 1) across both the camera IDs 302 (i.e., 1 and 3), enabling consistent person identification across the system 100 despite the short-term IDs 130 being temporary.

Further, the ID Manager 134 initially checks if the long-term ID 138 exists for the short-term ID 130 within the shared hash table 306. In an embodiment, the ID Manager 134 retrieves the long-term ID 138 if available within the shared hash table 306. For example, the person 304 (i.e., Person A) in the camera ID 302 (i.e., 1) is assigned the short-term ID 130 (i.e., 100) and the shared hash table 306 already contains a mapping of:
short-term ID 130 (e.g., 100)->long-term ID 138 (e.g., 1:1).

Then, the ID Manager 134 retrieves the long-term ID 138 (e.g., 1:2) for the short-term ID 130 (e.g., 100) from the shared hash table 306. In particular, as mentioned above, the format for long term ID is <long-term ID>: <entry id>.

In another embodiment, if the long-term ID 138 does not exist for a new short-term ID 130, then the Embedding Manager 132 is configured to map the new short-term ID 130 to an existing long-term ID 138 or create the new long-term ID 138 for the new-short term ID.

For example, suppose the person 304 (i.e., Person A) is being tracked by two camera IDs 302 (e.g., 1 and 3). Consider a scenario where the person 304 (i.e., Person A) is first detected by the camera ID 302 (e.g., 1). The short-term ID tracker 128a of the camera ID 302 (e.g., 1) assigns the short-term ID 130 (e.g. 100) to the person 304 (i.e., Person A). The Embedding Manager 132 processes the embedding vector 126 corresponding to the short-term ID 130 (e.g., 100). The ID Manager 134 checks the shared hash table 306 to see if the long-term ID 138 exists for the short-term ID 130 (e.g., 100). Since the person 304 (i.e., Person A) is being detected for the first time, no corresponding long-term ID 138 exists in the shared hash table 306. The ID Manager 134 assigns a new long-term ID 138 (e.g., 1:1) to the embedding vector 126 for the short-term ID 130 (e.g., 100). The shared hash table 306 is updated with the mapping of:
short-term ID 130 (e.g., 100)->long-term ID 138 (e.g., 1:1).

Now, consider a scenario (i.e., the long-term ID 138 does not exist and map the new short-term ID 130 to the existing long-term ID 138) where the person 304 (i.e., Person A) is detected by the camera ID 302 (i.e., 3). The short-term ID tracker 128c of the camera ID 302 (i.e., 3) assigns a different short-term ID 130 (e.g., 50) to the person 304 (i.e., Person A). The Embedding Manager 132 processes the embedding vector 126 corresponding to the short-term ID 130 (e.g., 50) and identifies that the embedding vector 126 matches the embedding vector 126 for the short-term ID 130 (e.g., 100). The ID Manager 134 checks the shared hash table 306 to see if the long-term ID 138 exists for the short-term ID 130 (i.e., 50). Since the short-term ID 130 (i.e., 50) is new, no entry exists in the shared hash table 306. However, based on the match of the embedding vector 126, the ID Manager 134 identifies that the person 304 (i.e., Person A) is already associated with the long-term ID 138 (i.e., 1:1) (from the short-term ID 130 (e.g., 100)). The ID Manager 134 retrieves the long-term ID 138 (i.e., 1:1) from the shared hash table 306. The shared hash table 306 is updated with an addition of a new mapping of the short-term ID 130 (i.e., 50)->long-term ID 138 (i.e., 1:3). The final shared hash table 306 may have two entries such as

short-term ID 130 (i.e., 100) -> long-term ID 138 (i.e., 1:1)
short-term ID 130 (i.e., 50) -> long-term ID 138 (i.e., 1:3)

Further, consider a scenario (i.e., the long-term ID 138 does not exist, and the new long-term ID 138 for the new short-term ID 130 is created) where the camera ID 302 (i.e., 3) detects the person 304 (i.e., Person B) for the first time. The short-term ID tracker 128c of the camera ID 302 (i.e., 3) assigns a different short-term ID 130 (i.e., 300) to the person 304 (i.e., Person B). The Embedding Manager 132 processes the embedding vector 126 corresponding to the short-term ID 130 (i.e., 300) and confirms that the embedding vector 126 does not match any existing embedding vectors 126 in the Tensor Database system 110. The ID Manager 134 checks the shared hash table 306 to see if the long-term ID 138 exists for the short-term ID 130 (i.e., 300). Since the person 304 (i.e., Person B) is being detected for the first time, no corresponding long-term ID 138 exists in the shared hash table 306. The ID Manager 134 assigns a new long-term ID 138 (e.g., 2:1) to the embedding vector 126 for the short-term ID 130 (i.e., 300). The shared hash table 306 is updated with the mapping of:
short-term ID 130 (i.e., 300)->long-term ID 138 (i.e., 2:1).

The final shared hash table 306 may have three entries, such as

short-term ID 130 (i.e., 100) -> long-term ID 138 (i.e., 1:1)
short-term ID 130 (i.e., 150) -> long-term ID 138 (i.e., 1:2)
short-term ID 130 (i.e., 300) -> long-term ID 138 (i.e., 2:1)

Once the long-term ID 138 is determined, then the Embedding Manager 132 updates the Tensor Database system 110 with a new record. The ID Manager 134 assigns the corresponding long-term ID 138 to the new record and updates the shared hash table 306. The long-term ID 138 is then available for the corresponding short-term ID 130 and is available for consumption by the dashboard 136.

In an exemplary scenario, as shown in FIG. 3, the camera IDs 302 (e.g., 1 and 3) detect the person 304 (i.e., Person A) and generate the embedding vectors 126 (E1, E2 and E3) using respective short-term ID trackers 128a-128c. The short-term ID trackers 128a-128c assign the short-term IDs 130 to the detected person 304 (i.e., Person A). For example, the short-term ID tracker 128a assigns the short-term ID 130 (i.e, 100) to the person 304 (i.e., Person A) captured by the camera ID 302 (i.e., 1), the short-term ID tracker 128b assigns the short-term ID 130 (i.e., 150) to the person 304 (i.e., Person A) captured again by the camera ID 302 (i.e., 1) and the short-term ID tracker 128c assigns the short-term ID 130 (i.e., 50) to the person 304 (i.e., Person A) captured by the camera ID 302 (i.e., 3).

For each short-term ID 130 (i.e., 100, 150, 50), a timestamp 308 is created. The timestamp 308 helps in synchronizing data for the processing of the embedding vector 126 and the assignment of the long-term ID 138. The embedding vectors 126 (i.e., E1, E2 and E3) are sent to the Embedding Manager 132, which processes the embedding vectors 126 and adds the embedding vectors 126 to the Tensor Database system 110. The ID Manager 134 uses the Tensor Database system 110 to check if the processed embedding vectors 126 correspond to an existing long-term ID 138. In a first scenario, if the match is found (e.g., embedding vector 126 (i.e., E3) matches the embedding vector 126 (i.e., E1) or the embedding vector 126 (i.e., E2) for the long-term ID 138 (i.e., 1:3)), then the ID Manager 134 maps the new short-term ID 130 (i.e., 50) to the existing long-term ID 138 (i.e., 1:3). In a second scenario, if no match is found, the ID Manager 134 creates the new long-term ID 138 for the embedding vector 126 (i.e., E3) and updates the shared hash table 306 accordingly.

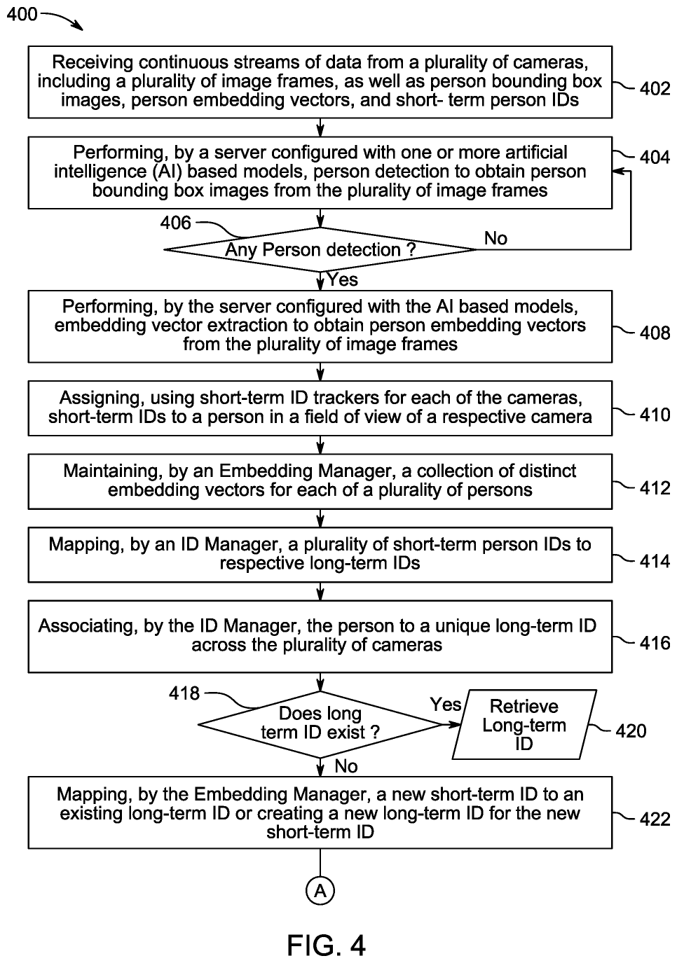

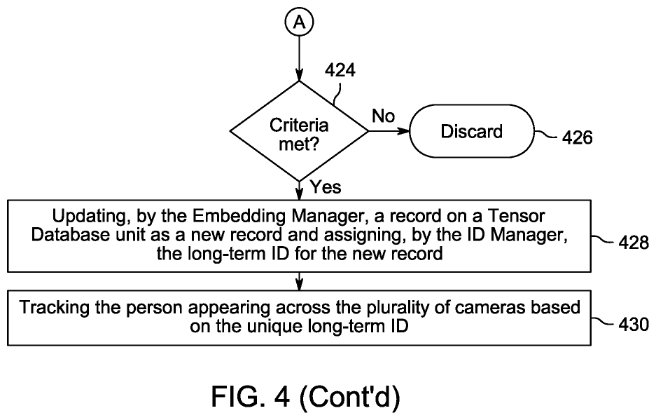

FIG. 4 illustrates a flowchart of a method 400 for tracking individual persons across the cameras 102 and over extended periods, according to certain embodiments. The method 400 includes a series of steps. These steps are only illustrative, and other alternatives may be considered where one or more steps are added, one or more steps are removed, or one or more steps are provided in a different sequence without departing from the scope of the present disclosure.

At step 402, the method 400 includes receiving the continuous streams of data from the multiple cameras 102. The continuous streams of data includes the image frames 118, the bounding box images 124, the embedding vectors 126, and the short-term person IDs 130. The continuous streams of data may be received by the event streaming processing circuitry 104.

At step 404, the method 400 includes performing, by the server 114 configured with the one or more AI based models 116, the person detection by the person detection module 120 to obtain the bounding box images 124. This step involves identifying whether any individual person is present in each image frame 118 using the detection algorithm. The detection algorithm can include YOLO-based detection AI models such as YOLO V8. This step further involves transmitting the output, including bounding box coordinates, confidence scores, class labels, and other outputs of the detection algorithm to decision step 406.

At step 406, the method 400 includes determining whether the output of the detection algorithm contains any individual person in the image frame 118 by analyzing the bounding box images 124. For example, if at least one valid bounding box labeled as “person” exists in the output, then the method 400 determines that the individual person is present in the image frame 118. The method 400 may proceed to step 408, if at least one individual person is detected in the image frame 118. Otherwise, the method 400 can step back to step 404.

At step 408, the method 400 includes performing, by the server 114 configured with the AI-based models 116, the embedding vector extraction by the feature extraction module 122 to obtain the person embedding vectors 126 from the image frames 118. This step involves extracting the features from each bounding box based on the appearance e.g., color texture, deep bodily features of the persons using the person re-identification AI models.

At step 410, the method 400 includes assigning, using the short-term ID trackers 128 for each of the cameras 102, the short-term IDs 130 to the person in the field of view of the respective camera 102.

At step 412, the method 400 includes maintaining, by the Embedding Manager 132, the collection of distinct embedding vectors for each of persons. This step also involves discarding, by the Embedding Manager 132, the redundant embedding vectors 244. This step further involves clustering 224 the embedding vectors 126 as a background process in order to manage the outlier embedding vectors 244 and discard the embedding vectors 244 that are grouped together based on the similarity distance threshold.

The method 400 further includes inputting, by the Embedding Manager 132 via the user interface 214, the configuration parameters including the sampling rate of time difference between the adjacent embedding vectors 126 corresponding to the short-term ID 130. The method 400 also includes inputting, by the Embedding Manager 132 via the user interface 214, the similarity distance threshold as a required measure between the existing embedding vector 126 in the Tensor Database system 110 and the new embedding vector 126. The method 400 also includes scheduling, via the user interface 214 for the Embedding Manager 132, execution of jobs for managing the Tensor Database system 110.

At step 414, the method 400 includes mapping, by the ID Manager 134, the short-term IDs 130 to the respective long-term IDs 138. This step includes maintaining, by the ID Manager 134, the shared hash table 306 that maps the short-term IDs 130 and the respective long-term ID 138 and synchronizing the ID Manager 134 with the Tensor Database system 110 to assign the respective long-term ID 138 within the shared hash table 306.

At step 416, the method 400 includes associating, by the ID Manager 134, the person to the unique long-term ID 138 across the cameras 102.

At step 418, the method 400 includes determining, by the ID Manager 134, whether the long-term ID 138 is available within the shared hash table 306. The method 400 proceeds to step 420 if the long-term ID 138 is available within the shared hash table 306. Otherwise, the method 400 may proceed to step 422.

At step 420, the method 400 includes retrieving, by the ID Manager 134, the long-term ID 138 from the shared hash table 306.

At step 422, the method 400 includes mapping, by the Embedding Manager 132, the new short-term ID 130 to the existing long-term ID 138 or creating the new long-term ID 138 for the new short-term ID 130.

At step 424, the method 400 includes checking specific criteria to ensure integrity, accuracy and consistency of the stored data (i.e., long-term IDs 138, the embedding vectors 126, the short-term IDs 130). The criteria may include long-term ID mapping validation (i.e., check if valid long-term ID 138 is mapped to the short-term ID 130), embedding vector quality check (i.e., validate the quality of the embedding vectors 126 based on the sampling rate and similarity distance threshold), duplicate record check (i.e., check if the similar embedding vector 126 or record for the same long-term ID 138 already exists in the Tensor Database system 110). The method 400 may proceed to step 428 if the criteria are met. Otherwise, the method 400 may proceed to step 426.

At step 426, the method 400 includes discarding the embedding vectors 126.

At step 428, the method 400 includes updating, by the Embedding Manager 132, the record on the Tensor Database system 110 as a new record and assigning, by the ID Manager 134, the long-term ID 138 for the new record.

At step 430, the method 400 includes tracking the person appearing across the cameras 102 based on the unique long-term ID 138.

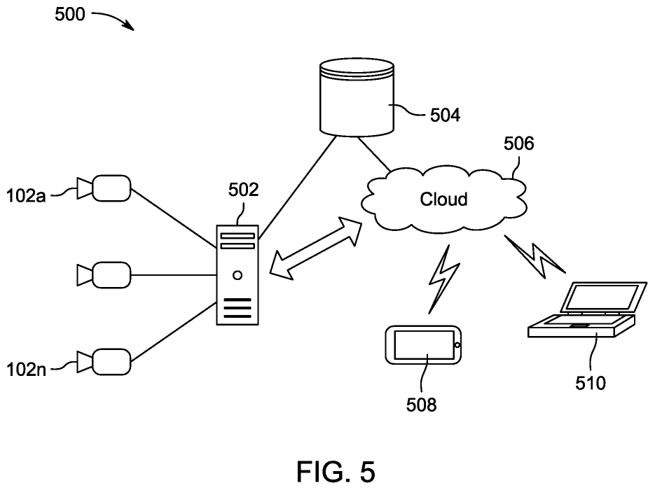

FIG. 5 illustrates a schematic diagram of a multi-camera system 500 with cloud-integrated person tracking and identification, according to certain embodiments. The multi-camera system 500 includes the cameras 102 that captures visual data, such as image streams or video streams, from a surrounding environment. The cameras 102 can be configured to capture the visual data for detecting the persons in the field of view. The cameras 102 can be configured to transmit the captured visual data to the processing unit 502. The cameras 102 can include, but are not limited to, Internet Protocol (IP) cameras, depth cameras, omnidirectional cameras, and so forth that may be capable of streaming the video feeds over a network. The video streams from the cameras 102 may include raw footage (image frames 118 or video frames) and metadata such as the timestamp 308 (as shown in FIG. 3) or the camera ID 302 (as shown in FIG. 3).

The processing unit 502 is configured to handle computations and processing tasks. For example, the processing unit 502, such as Graphical Processing unit (GPU) is useful for tasks requiring parallel processing such as handling the video streams, running deep learning algorithms, and evaluating the embedding vectors 126 (as shown in FIG. 1B) using the EM-SU1 210 (as shown in FIG. 2B) and EM-SU2 212 (as shown in FIG. 2B), and so forth. The processing unit 502 is configured to process the visual data received from the cameras 102 by running the deep learning algorithms for person detection, feature extraction and embedding vector generation. The processing unit 502 may also be configured to coordinate with a database 504 for storing and retrieving records such as the short-term IDs 130 (as shown in FIG. 1B) and the corresponding long-term IDs 138 (as shown in FIG. 1B). The processing unit 502 may also be configured to transmit the processed embedding vectors 126 to the database 504 for storage.

The database 504 acts as a centralized repository for storing the data associated with the system 100. The data can include the embedding vectors 126 generated by the Embedding Manager 132 (as shown in FIG. 1B), mappings of the short-term IDs 130 to the long-term ID 138 maintained by the ID Manager 134 (as shown in FIG. 1B), metadata like the timestamp 308, the camera ID 302 and location details. According to embodiments of the present disclosure, the database 504 may include, for example, but is not limited to, a centralized database, a distributed database, a personal database, an end-user database, a commercial database, a structured query language (SQL) database, a non-SQL database, an operational database, a relational database, a cloud database, an object-oriented database, a graph database, and so forth. Embodiments of the present disclosure are intended to include or otherwise cover any type of the database 504 including known, related art, and/or later developed technologies that may be capable of data storage and retrieval.

The cloud 506 provides a scalable and distributed infrastructure for managing large-scale data and making the data accessible to computing devices such as a mobile device 508 and a laptop 510. The cloud 506 acts as an intermediary between the database 504 and the computing devices. The cloud 506 may also be configured to provide computational power for additional processing. The cloud 506 is configured to share the processed data with the connected computing devices for monitoring or insights.

The cloud 506 serves as a centralized platform for data storage, processing, and synchronization, enabling seamless operation across distributed systems. The cloud 506 aggregates and stores the data from the cameras 102 and the processing unit 502. The data includes the embedding vectors 126, the long-term IDs 138, and historical tracking information, ensuring scalability and long-term accessibility. The cloud 506 performs real-time synchronization of information associated with the short-term IDs 130 and the long-term IDs 138, ensuring consistency across devices, and supports remote access through the computing devices for monitoring and control. Additionally, the cloud 506 handles advanced processing tasks, such as AI model inference and large-scale ID matching, reducing a computational burden on local devices. Furthermore, the cloud 506 facilitates updates and training of AI-based models, enhancing the efficiency and adaptability of the system 100.

The computing devices, such as the mobile device 508 or the laptop 510 provide an end-user interface for monitoring, analysing and interacting with the system 100. The users interact with the system 100 through the computing devices like the mobile device 508 or the laptop 510, accessing cloud-hosted applications or the dashboard 136 to manage and monitor the feeds of the camera 102.

The first embodiment is illustrated with respect to FIG. 1A-FIG. 3. The first embodiment discloses the system 100 for tracking individual persons across a plurality of cameras 102 and over extended periods. The system 100 includes the plurality of cameras 102. The system 100 further includes the event streaming processing circuitry 104 configured to receive continuous streams of data from the plurality of cameras 102, including the plurality of image frames 118, as well as person bounding box images 124, person embedding vectors 126, and short-term person IDs 130. The system 100 further includes the server 114 configured with one or more artificial intelligence (AI) based models 116 for person detection and embedding vector extraction to obtain the person bounding box images 124 and the person embedding vectors 126 from the plurality of image frames 118. The system 100 further includes the application processing circuitry 108 configured with the Embedding Manager 132 and the ID Manager 134. The Embedding Manager 132 maintains a collection of distinct embedding vectors for each of a plurality of persons. The ID Manager 134 is configured to map a plurality of short-term person IDs 130 to respective long-term IDs 138. The ID Manager 134 associates the person to a unique long-term ID 138 across the plurality of cameras 102. The system 100 further includes the Tensor Database system 110 for maintaining the extracted embedding vectors 126. The system 100 further includes the output device 112 configured to track the person appearing across the plurality of cameras 102 based on the long-term ID 138.

In an aspect, the Embedding Manager 132 is configured to discard redundant embedding vectors 244.

In an aspect, the Embedding Manager 132 is configured as a background process that clusters the embedding vectors 126.

In an aspect, the Embedding Manager 132 includes the user interface 214 for inputting configuration parameters, including a sampling rate of time difference between adjacent embedding vectors 126 corresponding to the short-term ID 130.

In an aspect, the user interface 214 for the Embedding Manager 132 inputs a similarity distance threshold as a required measure between an existing embedding vector 126 in the Tensor Database system 110 and a new embedding vector 126.

In an aspect, the Embedding Manager 132 clusters the embedding vectors 126 in order to manage outlier embedding vectors 244 and discard the embedding vectors 244 that are grouped together based on the similarity distance threshold.

In an aspect, the user interface 214 for the Embedding Manager 132 is configured for user scheduling execution of jobs for managing the Tensor Database system 110.

In an aspect, the system 100 includes the plurality of short-term ID trackers 128 for each of the plurality of cameras 102 for assigning the short-term IDs 130 to a person in a field of view of a respective camera 102.

In an aspect, the ID Manager 134 maintains a shared hash table 306 that maps the short-term IDs 130 and a respective long-term ID 138. The ID Manager 134 synchronizes with the Tensor Database system 110 to assign the respective long-term ID 138 within the shared hash table 306.

In an aspect, the ID Manager 134 retrieves the long-term ID 138 if available within the shared Hash Table 306, when the long-term ID 138 does not exist for a new short-term ID 130. The Embedding manager 132 is configured to map the new short-term ID 130 to an existing long-term ID 138 or create a new long-term ID for the new short-term ID 130. The Embedding Manager 132 is configured to update a record on the Tensor Database system 110 as a new record and then the ID Manager 134 assigns a long-term ID 138 for the new record.

The second embodiment is illustrated with respect to FIG. 4. The second embodiment discloses the computer-implemented method 400 for tracking individual persons across a plurality of cameras 102 and over extended periods. The method 400 includes receiving continuous streams of data from the plurality of cameras 102, including a plurality of image frames 118, as well as person bounding box images 124, person embedding vectors 126, and short-term person IDs 130. The method 400 further includes performing, by the server 114 configured with one or more artificial intelligence (AI) based models 116, person detection and embedding vector extraction to obtain the person bounding box images 124 and the person embedding vectors 126 from the plurality of image frames 118. The method 400 further includes maintaining, by an Embedding Manager 132, a collection of distinct embedding vectors for each of a plurality of persons. The method 400 further includes mapping, by an ID Manager 134, a plurality of short-term person IDs 130 to respective long-term IDs 138. The method 400 further includes associating, by the ID Manager 134, the person to a unique long-term ID 138 across the plurality of cameras 102. The method 400 further includes tracking the person appearing across the plurality of cameras 102 based on the unique long-term ID 138.

In an aspect, the method 400 further includes discarding, by the Embedding Manager 132, redundant embedding vectors 244.

In an aspect, the method 400 further includes clustering 224 the embedding vectors 126 as a background process.

In an aspect, the method 400 further includes inputting, by the Embedding Manager 132 via the user interface 214, configuration parameters including a sampling rate of time difference between adjacent embedding vectors 126 corresponding to the short-term ID 130.

In an aspect, the method 400 further includes inputting, by the Embedding Manager 132 via the user interface 214, a similarity distance threshold as a required measure between an existing embedding vector 126 in the Tensor Database system 110 and the new embedding vector 126.

In an aspect, the method 400 further includes clustering 224, by the Embedding Manager 132, the embedding vectors 126 in order to manage outlier embedding vectors 244 and discard embedding vectors 244 that are grouped together based on the similarity distance threshold.

In an aspect, the method 400 further includes scheduling, via the user interface 214 for the Embedding Manager 132, execution of jobs for managing the Tensor Database system 110.

In an aspect, the method 400 further includes assigning, using a plurality of short-term ID trackers 128 for each of the plurality of cameras 102, short-term IDs 130 to a person in a field of view of a respective camera 102.

In an aspect, the method 400 further includes maintaining, by the ID Manager 134, a shared hash table 306 that maps the short-term IDs 130 and a respective long-term ID 138. The method 400 further includes synchronizing the ID Manager 134 with a Tensor Database system 110 to assign the respective long-term ID 138 within the shared hash table 306.

In an aspect, the method 400 further includes retrieving, by the ID Manager 134, the long-term ID 138 if available within the shared Hash Table 306. The method 400 further includes mapping, by the Embedding manager 132, the new short-term ID 130 to an existing long-term ID 138 or creating a new long-term ID 138 for the new short-term ID 130 when the long-term ID 138 does not exist for a new short-term ID 130. The method 400 further includes updating, by the Embedding Manager 132, a record on the Tensor Database system 110 as a new record and assigning, by the ID Manager 134, a long-term ID 138 for the new record.

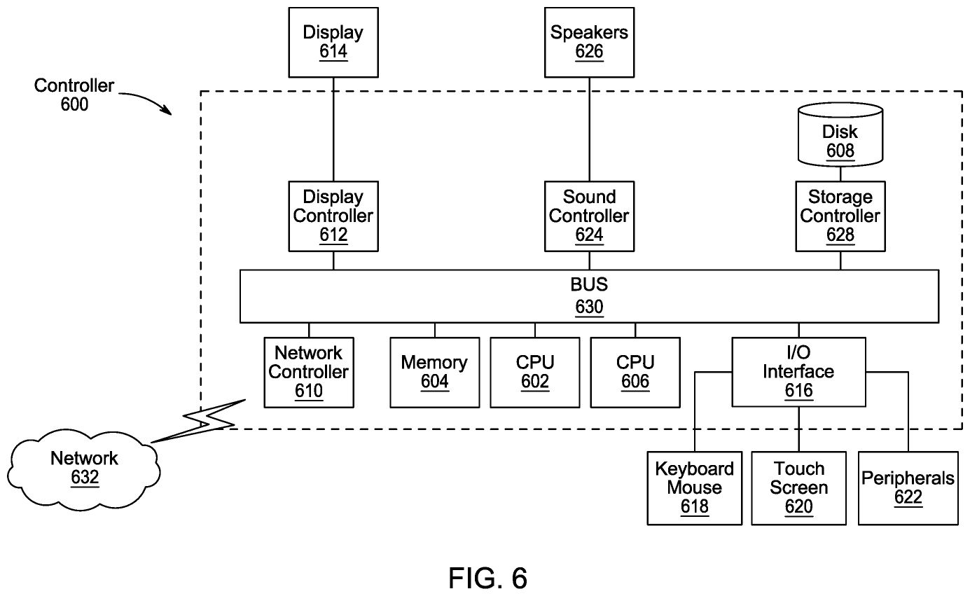

Next, further details of the hardware description of the computing environment according to exemplary embodiments are described with reference to FIG. 6. For purposes of this disclosure, the term unit described above is used interchangeably with processing circuitry configured to perform functions described herein. In FIG. 6, a controller 600 is described as representative of the system 100 of FIG. 1A in which the controller 600 includes a CPU 602 which performs the processes described above/below. The process data and instructions may be stored in a memory 604. These processes and instructions may also be stored on a storage medium disk 608, such as a hard drive (HDD) or a portable storage medium or may be stored remotely.

Further, the disclosure is not limited by the form of the computer-readable media on which the instructions of the inventive process are stored. For example, the instructions may be stored on compact discs (CDs), digital versatile disc (DVDs), in FLASH memory, read access memory (RAM), read only memory (ROM), programmable read only memory (PROM), erasable programmable read only memory (EPROM), electrically erasable programmable read only memory (EEPROM), hard disk or any other information processing device with which the computing device communicates, such as a server or computer.

Further, the disclosure may be provided as a utility application, background daemon, or component of an operating system, or combination thereof, executing in conjunction with CPU 602, 606 and an operating system such as Microsoft Windows 10, Microsoft Windows 11, UNiplexed Information Computing System (UNIX), Solaris, Lovable Intellect Not Using XP (LINUX), Apple Macintosh (MAC)-Operating System (OS) and other systems known to those skilled in the art.

The hardware elements in order to achieve the computing device may be realized by various circuitry elements, known to those skilled in the art. For example, CPU 602 or CPU 606 may be a Xenon or Core processor from Intel of America or an Opteron processor from advanced micro devices (AMD) of America, or may be other processor types that would be recognized by one of ordinary skill in the art. Alternatively, the CPU 602, 606 may be implemented on a field programmable Gate array (FPGA), application-specific integrated circuit (ASIC), programmable logic device (PLD) or using discrete logic circuits, as one of ordinary skill in the art would recognize. Further, CPU 602, 606 may be implemented as multiple processors cooperatively working in parallel to perform the instructions of the inventive processes described above.

The computing device in FIG. 6 also includes a network controller 610, such as an Intel Ethernet PRO network interface card from Intel Corporation of America, for interfacing with network 632. As can be appreciated, the network 632 can be a public network, such as the Internet, or a private network such as a local area network (LAN) or a wide area network (WAN) network, or any combination thereof and can also include public switched telephone network, (PSTN) or an integrated services digital network (ISDN) sub-network. The network 632 can also be wired, such as an Ethernet network, or can be wireless such as a cellular network including EDGE, 3G, 4G and 5G wireless cellular systems. The wireless network can also be Wireless Fidelity (WiFi), Bluetooth, or any other wireless form of communication that is known.

The computing device further includes a display controller 612, such as a NVIDIA GeForce GTX or Quadro graphics adaptor from NVIDIA Corporation of America for interfacing with display 614, such as a Hewlett Packard HPL2445w LCD monitor. A general purpose I/O interface 616 interfaces with a keyboard and/or mouse 618 as well as a touch screen panel 620 on or separate from display 614. General purpose I/O interface also connects to a variety of peripherals 622 including printers and scanners, such as an OfficeJet or DeskJet from Hewlett Packard.

A sound controller 624 is also provided in the computing device, such as Sound Blaster X-Fi Titanium from Creative, to interface with speakers/microphone 626 thereby providing sounds and/or music.

The general-purpose storage controller 628 connects the storage medium disk 608 with communication bus 630, which may be an instruction set architecture (ISA), extended industry standard architecture (EISA), video electronics standards association (VESA), peripheral component interconnect (PCI), or similar, for interconnecting all of the components of the computing device. A description of the general features and functionality of the display 614, keyboard and/or mouse 618, as well as the display controller 612, storage controller 628, network controller 610, sound controller 624, and general purpose I/O interface 616 is omitted herein for brevity as these features are known.

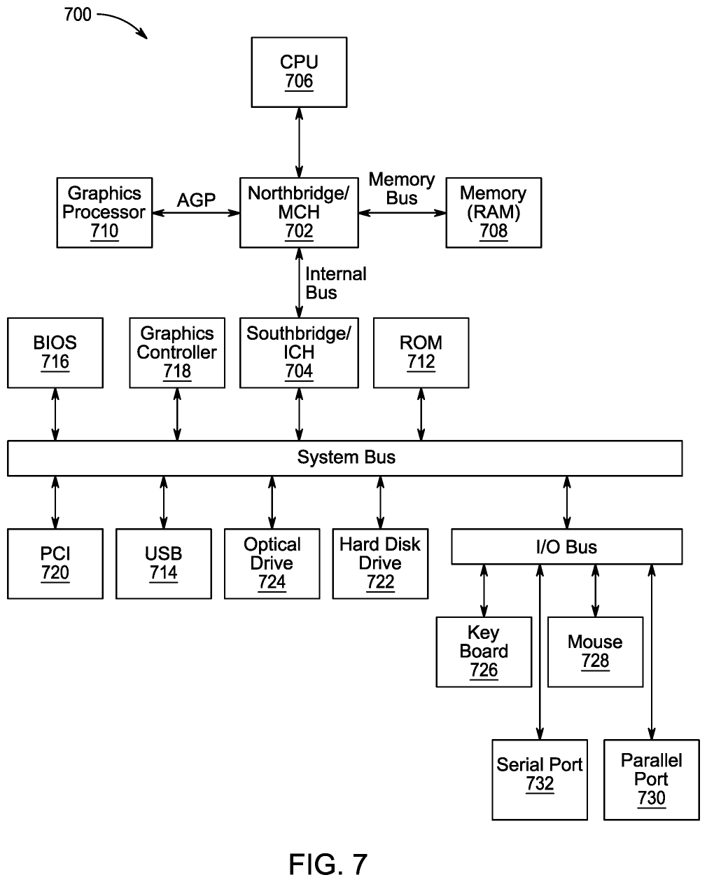

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown in FIG. 7.

FIG. 7 is an exemplary schematic diagram of a data processing system 700 used within the computing system, according to certain embodiments, for performing the functions of the exemplary embodiments. The data processing system 700 is an example of a computer in which code or instructions implementing the processes of the illustrative embodiments may be located.

In FIG. 7, the data processing system 700 employs a hub architecture including a north bridge and memory controller hub (NB/MCH) 702 and a south bridge and input/output (I/O) controller hub (SB/ICH) 704. The central processing unit (CPU) 706 is connected to the NB/MCH 702. The NB/MCH 702 also connects to the memory 708 via a memory bus, and connects to the graphics processor 710 via an accelerated graphics port (AGP). The NB/MCH 702 also connects to the SB/ICH 704 via an internal bus (e.g., a unified media interface or a direct media interface). The CPU 706 may contain one or more processors and even may be implemented using one or more heterogeneous processor systems.

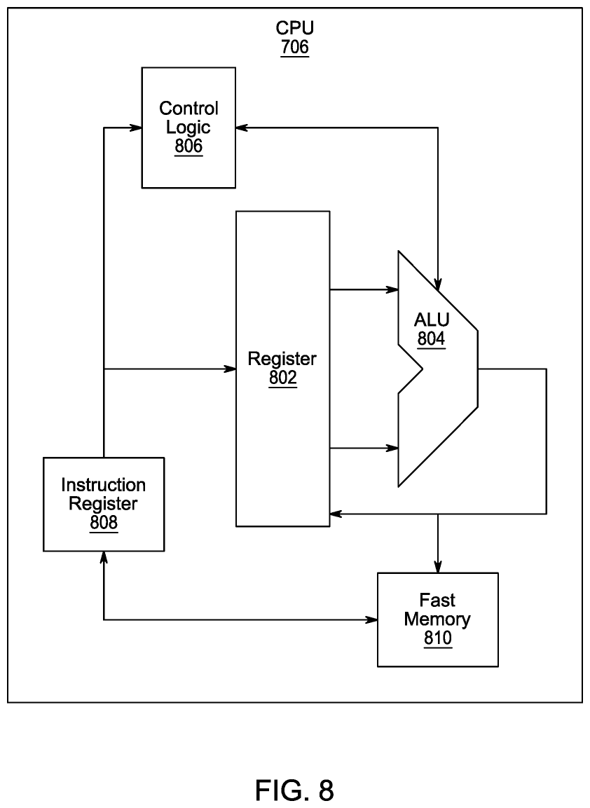

For example, FIG. 8 shows one implementation of the CPU 706. In one implementation, the instruction register 808 retrieves instructions from the fast memory 810. At least part of these instructions is fetched from the instruction register 808 by the control logic 806 and interpreted according to the instruction set architecture of the CPU 706. Part of the instructions can also be directed to the register 802. In one implementation the instructions are decoded according to a hardwired method, and in another implementation the instructions are decoded according to a microprogram that translates instructions into sets of CPU configuration signals that are applied sequentially over multiple clock pulses. After fetching and decoding the instructions, the instructions are executed using the arithmetic logic unit (ALU) 804 that loads values from the register 802 and performs logical and mathematical operations on the loaded values according to the instructions. The results from these operations can be feedback into the register 802 and/or stored in the fast memory 810. According to certain implementations, the instruction set architecture of the CPU 706 can use a reduced instruction set architecture, a complex instruction set architecture, a vector processor architecture, a very large instruction word architecture. Furthermore, the CPU 706 can be based on a Von Neuman model or a Harvard model. The CPU 706 can be a digital signal processor, the FPGA, the ASIC, the PLA, a PLD, or a CPLD. Further, the CPU 706 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 7, the data processing system 700 can include that the SB/ICH 704 is coupled through a system bus to an I/O Bus, a read only memory (ROM) 712, universal serial bus (USB) port 714, a flash binary input/output system (BIOS) 716, and a graphics controller 718. PCI/PCIe devices can also be coupled to SB/ICH 704 through a PCI bus 720.

The PCI devices may include, for example, Ethernet adapters, add-in cards, and PC cards for notebook computers. The Hard disk drive 722 and CD-ROM (optical drive) 724 can use, for example, an integrated drive electronics (IDE) or serial advanced technology attachment (SATA) interface. In one implementation the I/O bus can include a super I/O (SIO) device.

Further, the hard disk drive (HDD) 722 and optical drive 724 can also be coupled to the SB/ICH 704 through a system bus. In one implementation, a keyboard 726, a mouse 728, a parallel port 730, and a serial port 732 can be connected to the system bus through the I/O bus. Other peripherals and devices that can be connected to the SB/ICH 704 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

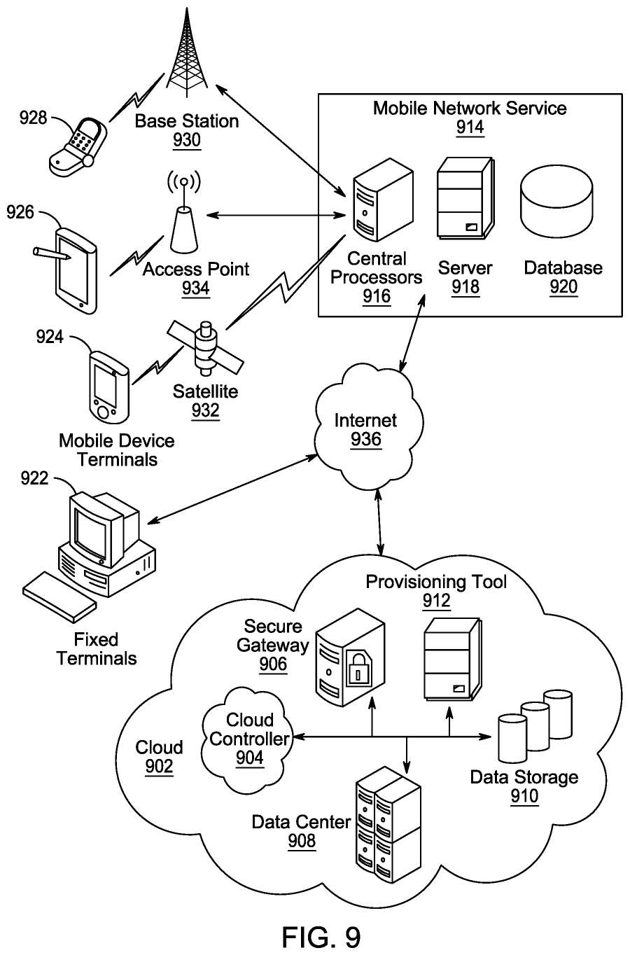

The functions and features described herein may also be executed by various distributed components of a system. For example, one or more processors may execute these system functions, wherein the processors are distributed across multiple components communicating in a network. The distributed components may include one or more client and server machines, such as cloud 902 including a cloud controller 904, a secure gateway 906, a data center 908, data storage 910 and a provisioning tool 912, and mobile network services 914 including central processors 916, a server 918 and a database 920, which may share processing, as shown by FIG. 9, in addition to various human interface and communication devices (e.g., display monitors 922, smart phones 924, tablets 926, personal digital assistants (PDAs) 928). The network may be a private network, such as a base station 930, satellite 932 or access point 934, or be a public network, such as the Internet 936. Input to the system may be received via direct user input and received remotely either in real-time or as a batch process. Additionally, some implementations may be performed on modules or hardware that are not identical to those described. Accordingly, other implementations are within the scope of the present disclosure.

The above-described hardware description is a non-limiting example of corresponding structure for performing the functionality described herein.

Numerous modifications and variations of the present disclosure are possible in light of the above teachings. It is, therefore, to be understood that the invention may be practiced otherwise than as specifically described herein.

1. A system for tracking individual persons across a plurality of cameras and over extended periods, comprising:
the plurality of cameras;
event streaming processing circuitry configured to receive continuous streams of data from the plurality of cameras, including a plurality of image frames, and output a plurality of short-term person IDs assigned to persons in a field of view of a camera of the plurality of cameras;
a server configured with one or more artificial intelligence (AI) based models for person detection and embedding vector extraction to obtain person bounding box images and person embedding vectors from the plurality of image frames;
application processing circuitry configured with an Embedding Manager and an ID Manager, wherein the Embedding Manager maintains a collection of distinct embedding vectors for each of a plurality of persons, wherein the ID Manager is configured to map the plurality of short-term person IDs for a person to respective long-term IDs, wherein the ID Manager associates the person to a unique long-term ID across the plurality of cameras;
a Tensor Database system for maintaining the extracted embedding vectors; and
an output device configured to track the person appearing across the plurality of cameras based on the long-term ID.

2. The system of claim 1, wherein the Embedding Manager is configured to discard redundant embedding vectors.

3. The system of claim 1, wherein the Embedding Manager is configured as a background process that clusters the embedding vectors.

4. The system of claim 3, wherein the Embedding Manager includes a user interface for inputting configuration parameters including a sampling rate of time difference between adjacent embedding vectors corresponding to a short-term ID.

5. The system of claim 4, wherein the user interface for the Embedding Manager inputs a similarity distance threshold as a required measure between an existing embedding vector in the Tensor Database system and a new embedding vector.

6. The system of claim 5, wherein the Embedding Manager clusters the embedding vectors in order to manage outlier embedding vectors and discard embedding vectors that are grouped together based on the similarity distance threshold.

7. The system of claim 4, wherein the user interface for the Embedding Manager is configured for user scheduling execution of jobs for managing the Tensor Database system.

8. The system of claim 1, wherein the event streaming processing circuitry includes a plurality of feature-of-interest (FoI) detectors and a FoI manager,
wherein the FoI detectors include artificial intelligence models for detecting particular FoI, and
wherein the FoI manager is configured to increase or decrease a number of the plurality of FoI detectors based on computational load.

9. The system of claim 8, wherein the event streaming processing circuitry includes a plurality of short-term ID trackers for each of the plurality of cameras for assigning the short-term IDs to a person in a field of view of a respective camera, and
wherein the ID Manager maintains a shared hash table that maps the short-term IDs and a respective long-term ID, wherein the ID Manager synchronizes with the Tensor Database system to assign the respective long-term ID within the shared hash table.

10. The system of claim 9, wherein the ID Manager retrieves the long-term ID if available within the shared Hash Table,
when the long-term ID does not exist for a new short-term ID, the Embedding manager is configured to map the new short-term ID to an existing long-term ID or create a new long-term ID for the new short-term ID, and
wherein the Embedding Manager is configured to update a record on the Tensor Database system as a new record and then the ID Manager assigns a long-term ID for the new record.

11. A method for tracking individual persons across a plurality of cameras and over extended periods, comprising:
receiving continuous streams of data from the plurality of cameras, including a plurality of image frames, and output a plurality of short-term person IDs assigned to persons in a field of view of a camera of the plurality of cameras;
performing, by a server configured with one or more artificial intelligence (AI) based models, person detection and embedding vector extraction to obtain person bounding box images and person embedding vectors from the plurality of image frames;
maintaining, by an Embedding Manager, a collection of distinct embedding vectors for each of a plurality of persons;
mapping, by an ID Manager, the plurality of short-term person IDs for a person to respective long-term IDs;
associating, by the ID Manager, the person to a unique long-term ID across the plurality of cameras; and
tracking the person appearing across the plurality of cameras based on the unique long-term ID.

12. The method of claim 11, further comprising discarding, by the Embedding Manager, redundant embedding vectors.

13. The method of claim 11, further comprising clustering the embedding vectors as a background process.

14. The method of claim 13, further comprising inputting, by the Embedding Manager via a user interface, configuration parameters including a sampling rate of time difference between adjacent embedding vectors corresponding to a short-term ID.

15. The method of claim 14, further comprising inputting, by the Embedding Manager via the user interface, a similarity distance threshold as a required measure between an existing embedding vector in a Tensor Database system and a new embedding vector.

16. The method of claim 15, further comprising clustering, by the Embedding Manager, the embedding vectors in order to manage outlier embedding vectors and discard embedding vectors that are grouped together based on the similarity distance threshold.

17. The method of claim 15, further comprising scheduling, via the user interface for the Embedding Manager, execution of jobs for managing the Tensor Database system.

18. The method of claim 11, wherein event streaming processing circuitry includes a plurality of feature-of-interest (FoI) detectors and a FoI manager, wherein the FoI detectors include artificial intelligence models for detecting particular FoI.
the method further comprising increasing or decreasing, by the FoI manager, a number of the plurality of FoI detectors based on computational load.

19. The method of claim 18, further comprising:
assigning, using a plurality of short-term ID trackers for each of the plurality of cameras, the short-term IDs to a person in a field of view of a respective camera; and
maintaining, by the ID Manager, a shared hash table that maps the short-term IDs and a respective long-term ID; and synchronizing the ID Manager with a Tensor Database system to assign the respective long-term ID within the shared hash table.

20. The method of claim 19, further comprising retrieving, by the ID Manager, the long-term ID if available within the shared Hash Table,
when the long-term ID does not exist for a new short-term ID, mapping, by the Embedding manager, the new short-term ID to an existing long-term ID or creating a new long-term ID for the new short-term ID; and
updating, by the Embedding Manager, a record on the Tensor Database system as a new record and assigning, by the ID Manager, a long-term ID for the new record.
